(19) United States
(12) Patent Application Publication
(10) Pub. No.: US 2023/0220288 A1
(43) Pub. Date: Jul. 13, 2023

(54) CIRCULATION CONTROL IN DUAL BED GASIFIERS

(71) Applicant: Highbury Energy Inc., Vancouver (CA)

(72) Inventors: Yong Hua LI, Vancouver (CA); Wei WANG, Vancouver (CA); Alan Paul WATKINSON, Vancouver (CA)

(21) Appl. No.: 18/153,874

(22) Filed: Jan. 12, 2023

Related U.S. Application Data
(60) Provisional application No. 63/298,990, filed on Jan. 12, 2022.

(51) Int. Cl. C10J 3/72; C10J 3/48

(52) U.S. Cl. CPC C10J 3/723; C10J 3/482; C10J 2200/09

(57) ABSTRACT

A solid circulation monitoring and/or control system for a dual bed gasification apparatus. The monitoring and/or control system comprises a plurality of pressure sensors located at various regions within the dual bed gasification system, for monitoring pressure while the apparatus is operated. Comparison of pressures and pressure differentials between different regions of the gasifier allow monitoring of the status, and optimization of the operation conditions of the apparatus.

### CROSS-REFERENCE TO RELATED APPLICATION

This application claims the benefit of priority to U.S. Provisional Patent Application No. 63/298,990, filed Jan. 12, 2022, titled CIRCULATION CONTROL IN DUAL BED GASIFIERS, the contents of which are hereby expressly incorporated into the present application by reference in their entirety.

### FIELD OF THE INVENTION

The invention relates to control, monitoring, and optimization systems for dual bed gasifiers.

### BACKGROUND

Gasification of carbonaceous solids yields product gases that can be used as a fuel gas or converted to various liquid fuel or chemical products. Gasification requires heat. With indirect gasification systems, the heat is generated outside the gasification vessel. With dual-bed gasification systems, such as the gasification system (30) depicted in FIG. 1, a heat carrier, typically heat carrier particles (32) such as silica or olivine sand is continuously circulated from a char combustor vessel (34) where it is heated to over 900° C., to the biomass gasifier vessel (36) at about 830° C., where it provides heat for the gasification step. The production rate of the gasifier is dictated by the heat transferred to the gasifier stage (36), Q_{g}, which is proportional to [m (T_{c}-T_{g})], where m is the circulation rate (kg/s), and (T_{c}-T_{g}) is the temperature difference between the combustor top (38) and the gasifier bed (40). Further, the dual-bed system must provide gas sealing of the oxidizing conditions of the char combustor vessel (34), and the reducing conditions of the biomass gasifier vessel (36). Thus, the circulation rate is of key importance.

The recirculation rate of the heat carrier particles (32) should be controlled such that sufficient hot solids enter the gasifier (36) to maintain the temperature and gasification rate in spite of unplanned variations in upstream conditions such as biomass feed rate, biomass moisture content, steam flow and steam temperature, or downstream conditions such as downstream pressure, which could be raised by gradual blockage of a secondary cyclone, or a filter. Such variations will affect the circulation rate necessary to maintain the desired set points of the process (e. g., temperature in the gasifier bed (40) or combustor top (38)).

Although the importance of the circulation rate is widely recognized in the technical literature, on the industrial scale, there is no established method to measure the circulation rate directly because of the high temperatures and complex gas-solids flow regimes encountered.

There are several types of gasifiers and char combustor vessels known in the art. The gasifier (36) may be a vertical up-flow reactor characterized by relatively small reactor diameter, high gas velocity and high fraction voidage [>0.8] in which solids and gas flow co-currently upwards, with solids exiting at the reactor top, or a bubbling fluidized bed (as shown in FIG. 1) characterized by relatively larger diameter, smaller height, lower gas velocity, mixed gas-solids flow of low voidage, and solids exiting near the bottom. Similarly, the char combustor (34) may be either a vertical fast fluidized bed riser unit, or a bubbling fluidized bed unit. The invention is hereindescribed in relation to the combination of a bubbling fluidized bed gasifier, and a riser reactor for char combustion, though the presently disclosed systems may work with either type of gasifier and either type of char combustor. With all units, cyclones are common for solid/gas separation. As shown, a gasifier primary cyclone (42) aids with solid/gas separation exiting the BFB gasifier (36), with separated solids being sent back to the gasifier (36) through gasifier down-corner (44), and raw syngas exiting the gasifier primary cyclone (42) and being transported to a gasifier secondary cyclone (48) for further solid/gas separation. Heat carrier particles, often in the form of fine sand and char, exit the gasifier secondary cyclone (48) and are fed back to the CFB combustor (34) via a solid screw conveyor (52). Optionally, and as shown, the syngas is then fed into a combustor secondary cyclone (54), with heat carrier particles again fed back to the CFB combustor (34) via a solid screw conveyor (52). A combustor primary cyclone (56) aids with solid/gas separation exiting the CFB combustor (34), with heat carrier particles fed from the combustor primary cyclone (56) down combustor down-comer (58), through a non-mechanical device (60) to the gasifier (36). Flue gas (62) exits the combustor primary cyclone (56) and is fed to the combustor secondary cyclone (54), where flue gas exit as gas and heat carrier particles are fed back to the CFB combustor (34). Cooler heat carrier particles leave BFB gasifier (36) through solid exit standpipe non-mechanical device (64) and are fed back to the CFB combustor (34).

Gas-solid down-flow in both dilute or dense phase occurs in the cyclone down-comers (44, 58). Solids pass between gasifier and combustor reactors via followed non-mechanical devices (60), (64), which may be loop seals (80), U-bends, J-valves (84), approximated J-valves (86), L-valves (82) or seal pots (88), as shown schematically in FIG. 2. Solid flow is generally controlled by adjusting the aeration gas flow through the non-mechanical device under a typical under flow standpipe.

Biomass (106) is fed into the gasifier (36) via a biomass hopper (108) and a screw feeder (110). The biomass (106) is heated in the gasifier (36) resulting in generation of syngas, which leaves through the gasifier freeboard (92) into the gasifier primary cyclone (42).

Table 1 lists the type of gas/solid two-phase flow encountered in different parts of the dual-bed system, typical flow direction, voidages and solids concentrations encountered. Gas velocities in both gasifier (36) and combustor (34) are set in their corresponding ranges, i.e., combustor in fast fluidized regime, e.g., 4-10 m/s, gasifier in the bubbling fluidized regime, e.g., 0.2-0.5 m/s. Factors that affect the solid recirculation rate include pressure difference between gasifier and combustor, aeration rate to the non-mechanical valves, combustor flue gas velocity, gasifier bed height and downstream pressure. Because of the complexity of the multi-phase flows, with varying solids/gas mass ratios around the loop, a purely theoretical calculation of the solids recirculation rate is not useful for process control purposes.

TABLE 1
Typical solids concentration and voidage in different parts of a dual bed (DB) flow loop

| Flow Location | | | | Solids | | Typical |
|---|---|---|---|---|---|---|
| (FIG. 1) | Type of Flow | Flow Direction | Solids | Concn. | | Voidage |
| Gasifier Dense Bed | Bubbling | Gas-Up | Biomass | 30-50% | V | 0.6~0.8 |
| | | Solid Suspensior | BM*, Char | | | |
| Gasifier Freeboard | Diluted Solid | Gas-Up | BM, Char, Ash | Low | | High |
| | | | | (e.g., <2% V) | | (e.g., >0.98) |
| Gasifier Stand-Pipe | Moving Bed | Solid Down | BM, Char | ~50% | V | ~0.5 |
| Lower Loop Seal | Moving Bed | Solid Down | BM, Char | ~50% | V | ~0.5 |
| Combustor Riser | Diluted Solid | Gas and Solid Up | BM, Char | 2-20% | V | 0.8~0.98 |
| Cyclone Downcomer Top | Diluted Sloid | Solid Down | BM | Low | | 0.95~0.98 |
| | | | | (e.g., <1% V) | | |
| Cyclone Downcomer Bottom | Moving Bed | Solid Down | BM | ~50% | V | ~0.5 |
| Upper Loop Seal | Moving Bed | Solid Down | BM | ~50% | V | ~0.5 |

*Bed Material

Gasifier dense bed (90), Gasifier freeboard (92) lower loop seal (94), combustor riser (96), cyclone downcomer top (98), cyclone downcomer bottom (100), and upper loop seal (102) are all shown in FIG. 1.

It is evident from Table 1, that the type of solids found in the system varies around the loop from bed material, bed material/char mixtures, and bed material/char/ash mixtures. Each type of solid has a different density and particle size distribution. Concentration of solids in the gas stream also changes with location in the loop from a high of about 50% solids by volume to a low of below 2% solids by volume. Solids flow direction may be upwards, as in the combustor (34), downwards, as in the cyclone downcomers (58, 44), or mixed as in the bubbling bed gasifier (36). Gas velocities may be low or high, depending on which part of the loop is considered. Thus the gas-solids flows are complex, and flow behaviour may be difficult to predict.

### BRIEF DESCRIPTION OF FIGURES

FIG. 1 is a schematic representation of a typical prior art dual bed gasifier.

FIG. 2 is a schematic representation of several prior art non-mechanical valves.

FIG. 3 is a schematic representation of a dual bed gasifier system exemplifying a monitoring system of the present invention.

FIG. 4 is a schematic representation of a dual bed gasifier system exemplifying a monitoring system of the present invention.

FIG. 5 shows typical pressure profiles of the gasifiers shown in FIGS. 3 and 4.

FIG. 6 shows a schematic representation of a dual bed gasifier system of the present invention, depicting the circulation loop and the associated pressure and temperature instrumentation.

FIG. 7 shows BFB bed temperatures during a transition period, for which the dual bed was switched from combustion preheating to biomass steam gasification.

FIG. 8 shows solid recirculation loop pressures at a point in time in Example Case 1.

FIG. 9 plots the solid recirculation loop pressures vs. height at specific times in Example Case 1.

FIG. 10 shows solid recirculation loop pressures at a different point in time in Example

Case 1.

FIGS. 11 and 12 show BFB bed temperature and pressure variations caused by a disturbance after addition of cold sand (Example Case 2).

FIG. 13 shows recirculation loop pressures at four specific time points in Example Case 2.

FIG. 14 shows BFB bed temperatures over three hours during an experimental run in Example Case 3.

FIG. 15 shows recirculation loop pressures over time in Example Case 3.

FIG. 16 shows five sets of loop pressure v. height at specific times in Example Case 3.

FIG. 17 shows schematics of the downcomer solid moving bed at different times in Example Case 3.

FIG. 18 shows pressure profiles of one-hour solid recirculation during the gasification stage in Example Case 4.

FIG. 19 shows positions of pressure measurements in the solid recirculation loop at specific times in Example Case 4.

FIG. 20 is a simplified fluid-particle phase diagram.

FIG. 21 shows a schematic representation of a control system of the present invention.

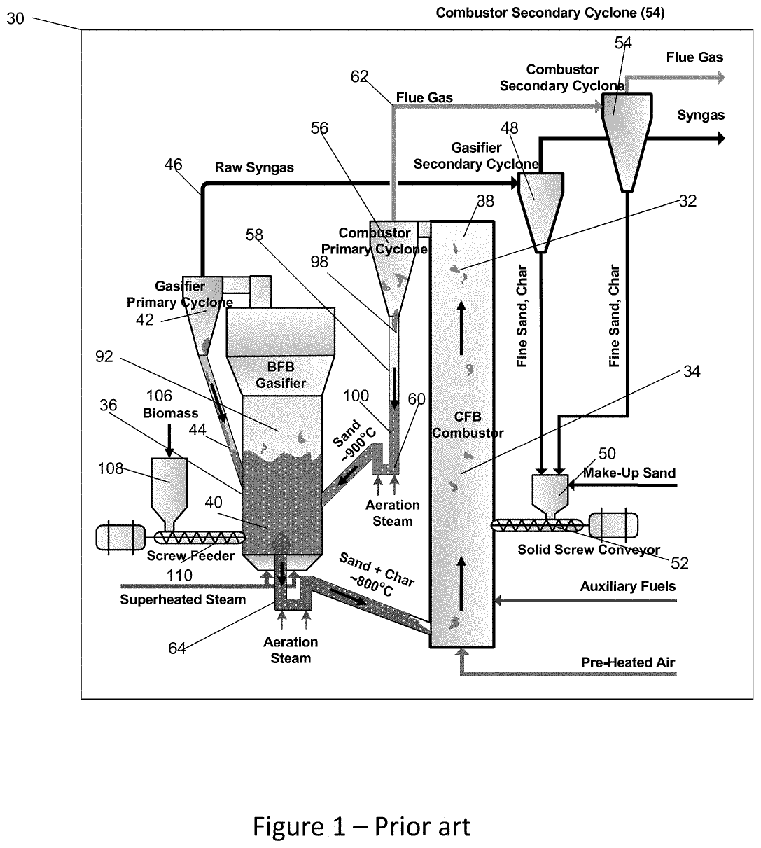

### SUMMARY OF THE INVENTION

According to one aspect of the present invention is provided a solid circulation monitoring system for a dual-bed gasification apparatus, said dual-bed gasification apparatus comprising: a gasifier having a bed and a freeboard; a combustor having a bottom end and a top end; a lower branch conduit connecting the gasifier to the combustor; said lower branch conduit configured to allow transfer of heat carrier particles from the gasifier to the combustor; an upper branch conduit connecting the combustor to the gasifier; said upper branch conduit configured to allow transfer of heat carrier particles from the combustor to the gasifier; said upper branch conduit having an upper portion, a middle portion, and a lower portion; said monitoring system comprising a plurality of pressure sensors, each measuring a pressure at a location within the dual-bed gasification apparatus while the dual-bed gasification apparatus is in operation.

According to certain embodiments, the monitoring system further comprises a plurality of temperature sensors, each measuring a temperature at a location within the dual-bed gasification apparatus while the dual-bed gasification apparatus is in operation.

According to certain embodiments, the plurality of pressure sensors comprise two or more of: a pressure sensor P1 measuring a pressure PR1 within the freeboard; a pressure sensor P2 measuring a pressure PR2 within the gasifier bed; a pressure sensor P3 measuring a pressure PR3 in said lower branch conduit; a pressure sensor P4 measuring a pressure PR4 in said bottom end of the combustor; a pressure sensor P5 measuring a pressure PR5 in said top end of the combustor; a pressure sensor P6 measuring a pressure PR6 in the top of the upper branch conduit; a pressure sensor P7 measuring a pressure PR7 within the upper portion of the upper branch conduit; optionally, one or more further pressure sensors P7A measuring a pressure PR7A within the upper portion of the upper branch conduit; a pressure sensor P8 measuring a pressure PR8 within the lower portion of the upper branch conduit; optionally, one or more further pressure sensors P8A measuring a pressure PR8A within the lower portion of the upper branch conduit; a pressure sensor P9 measuring a pressure PR9 within the lower portion of the upper branch conduit and downstream of pressure sensor P8.

According to certain embodiments, the plurality of temperature sensors comprise two or more of: a temperature sensor T1 measuring a temperature TP1 at the bottom end of the combustor; a temperature sensor T2 measuring a temperature TP2 in said top end of the combustor; a temperature sensor T3 measuring a temperature TP3 directly upstream of the gasifier bed; and a temperature sensor T4 measuring a temperature TP4 within the gasifier bed.

According to certain embodiments, the monitoring system comprises pressure sensor P1 and pressure sensor P2.

According to certain embodiments, the monitoring system comprises pressure sensor P2, pressure sensor P3, and pressure sensor P4.

According to certain embodiments, the monitoring system comprises pressure sensor P2, pressure sensor P7, pressure sensor P8, and pressure sensor P9, and optionally further comprises pressure sensor P3.

According to certain embodiments, the monitoring system comprises pressure sensor P4 and pressure sensor P5.

According to certain embodiments, the monitoring system comprises pressure sensor P7, pressure sensor P8, and pressure sensor P9, and optionally further comprises pressure sensor P2 and pressure sensor P3.

According to certain embodiments, the monitoring system comprises pressure sensor P1, pressure sensor P2, pressure sensor P3, pressure sensor P4, pressure sensor P5, pressure sensor P6, pressure sensor P7, pressure sensor P8 and pressure sensor P9.

According to a further aspect of the present invention is provided a system for controlling solids circulation in a dual-bed gasification apparatus, said dual-bed gasification apparatus comprising: a gasifier having a bed and a freeboard; a combustor having a bottom end and a top end; a lower branch conduit connecting the gasifier to the combustor; said lower branch conduit configured to allow transfer of heat carrier particles from the gasifier to the combustor; said lower branch conduit optionally having a lower branch non-mechanical device permitting control of rate of passage of said heat carrier particles from the gasifier to the combustor; an upper branch conduit connecting the combustor to the gasifier; said upper branch conduit configured to allow transfer of heat carrier particles from the combustor to the gasifier; said upper branch conduit having an upper portion, a middle portion, and a lower portion; said lower portion of the upper branch conduit optionally having an upper branch non-mechanic device permitting control of rate of passage of said heat carrier particles from the combustor to the gasifier; said control system comprising the monitoring system as hereindescribed, wherein the lower branch non-mechanical device and/or the upper branch non-mechanical device are operated to increase or decrease the passage of said heat carrier particles in response to changes in pressure PR1, PR2, PR3, PR4, PRS, PR6, PR7, PR8, and/or PR9.

In certain embodiments, the lower branch non-mechanical device and/or the upper branch non-mechanical device is an L-valve, a J-valve, an approximated J-valve, a seal pot, a U-bend, or a loop seal, and the operating of said non-mechanical device comprises adjusting a rate of flow of aeration gas through said non-mechanical device.

In certain embodiments, the system for controlling solids circulation further comprises upper aeration ports in said upper branch conduit and/or lower aeration ports in said lower branch conduit, and the upper aeration ports and/or lower aeration ports are operated to increase or decrease the passage of said heat carrier particles in response to changes in pressure PR1, PR2, PR3, PR4, PR5, PR6, PR7, PR8, and/or PR9.

In certain embodiments, the operating of the lower branch non-mechanical device and/or the upper branch non-mechanical device occurs in an automated fashion in response to the change in pressure PR1, PR2, PR3, PR4, PR5, PR6, PR7, PR8, and/or PR9.

According to a further embodiment of the present invention is provided a method for controlling solids circulation in a dual-bed gasification apparatus, said dual-bed gasification apparatus comprising: a gasifier having a bed and a freeboard; a combustor having a bottom end and a top end; a lower branch conduit connecting the gasifier to the combustor; said lower branch conduit configured to allow transfer of heat carrier particles from the gasifier to the combustor; said lower branch conduit optionally having a lower branch non-mechanical device permitting control of rate of passage of said heat carrier particles from the gasifier to the combustor; an upper branch conduit connecting the combustor to the gasifier; said upper branch conduit configured to allow transfer of heat carrier particles from the combustor to the gasifier; said upper branch conduit having an upper portion, a middle portion, and a lower portion; said lower portion of the upper branch conduit optionally having an upper branch non-mechanical device permitting control of rate of passage of said heat carrier particles from the combustor to the gasifier; said method comprising monitoring, while the dual-bed gasification apparatus is in operation, a plurality of pressures, each pressure at a location within the dual-bed gasification apparatus, and increasing or decreasing one or more of: (a) the rate of passage of the heat carrier particles from the combustor to the gasifier by operating the upper branch non-mechanic device; and (b) increasing or decreasing the rate of passage of the heat carrier particles from the gasifier to the combustor, by operating the lower branch non-mechanic device; when one or more of said plurality of pressures, or where the difference between two of said plurality of pressures reach a defined threshold.

In certain embodiments, the method further comprises increasing or decreasing an aeration gas flow to the lower portion and/or the middle portion of the upper branch conduit, when one or more of said plurality of pressures, or where the difference between two of said plurality of pressures, reach a defined threshold.

In certain embodiments, the plurality of pressures comprise two or more of: a pressure PR1 within the freeboard; a pressure PR2 within the gasifier bed; a pressure PR3 in said lower branch conduit; a pressure PR4 in said bottom end of the combustor; a pressure PR5 in said top end of the combustor; a pressure PR6 in the top of the upper branch conduit; a pressure PR7 within an upper portion of the upper branch conduit; a pressure PR8 within the lower portion of the upper branch conduit; a pressure PR9 within the lower portion of the upper branch conduit and downstream of pressure sensor P8.

### DETAILED DESCRIPTION

Measurement of Variables and Controlled Parameters in Dual-Bed Gasification

Conventional parameters in the dual bed gasification system such as biomass feed rate, biomass moisture content, steam flow, steam temperature, combustion air flow, etc., are measured and controlled by conventional means, with direct measurements usually possible. For example, the moisture content of biomass exiting an upstream dryer and entering the gasifier can be measured via automated analyzers, and the fuel and air to the dryer can be adjusted to provide more or less heat, raising or lowering the moisture as needed.

Table 2 lists some operational variables which are readily measured by conventional instruments and may be used in certain embodiments to provide information for part of the presently described control and monitoring system.

TABLE 2
Process Operational Variables Measured by Conventional Means
Operational Variables

Biomass Moisture Content
Biomass Feed Rate
Steam to Gasifier: Mass Flow Rate and Superheated Temperature
Combustion Air Flow Rate and Pre-Heating Temperature
Supplemental Fuel Gas Flow Rate to Combustor
Make-Up Heat Carrier (Bed Material) Feed Rate

Table 3 lists some parameters in the Dual Bed system which may be controlled via conventional means. It is notable that solids circulation is not among those variables controlled by conventional means.

It is noted that the presently described control and monitoring system can be used in conjunction or collaboration with a conventional control system, and the data provided therefrom.

TABLE 3
Typical Parameters Controlled by Conventional Means
Controlled Parameters

Biomass Moisture Content to Gasifier
Gasifier Dense Bed Temperature
Gasifier Bottom Pressure
Gasifier Dense Bed Pressure Drop
Combustor Top Temperature
Combustor Inlet Pressure
Combustor Flue Gas O₂ Content

In an industrial scale dual-bed gasifier system, numerous variables can be measured and controlled. For example, variations of biomass moisture within a certain limited extent to the gasifier may lead to the rise or fall of the gasifier bed temperature. Instead of control action at the upstream biomass dryer, an increase or decrease of the solid circulation rate has been found to be an effective means to bring the system to a new steady condition. On the other hand, certain conditions arise that depress the circulation rate, such as, disturbances to cyclone downcomer solids flow with the slugging formation or downflow with minimum vibrated packed voidage, εₚ. Corrective actions to bring the solid circulation rate to the previous set point would be necessary. However, because of the two-phase flow complexity around the recirculation loop (very large range of mass solids/mass gases at different points in the loop), and the high temperatures involved, one of the prime governing variables, the solids circulation rate, can not be measured directly.

In current industrial practice, the circulation is normally calculated from an overall energy balance of the dual-bed system, since it cannot be directly measured. The overall energy balance contains a number of terms of which calculations are subject to significant errors or approximations, because of the complexity of multi-phase (gas-solids) flows (different flow regimes in different parts of the circulation loop). Thus, there is a need for a system which allows more direct measures, or calculations for flow conditions which are better defined.

Current Technology for Solids Circulation Using Non-Mechanical Valves and Sealing Devices

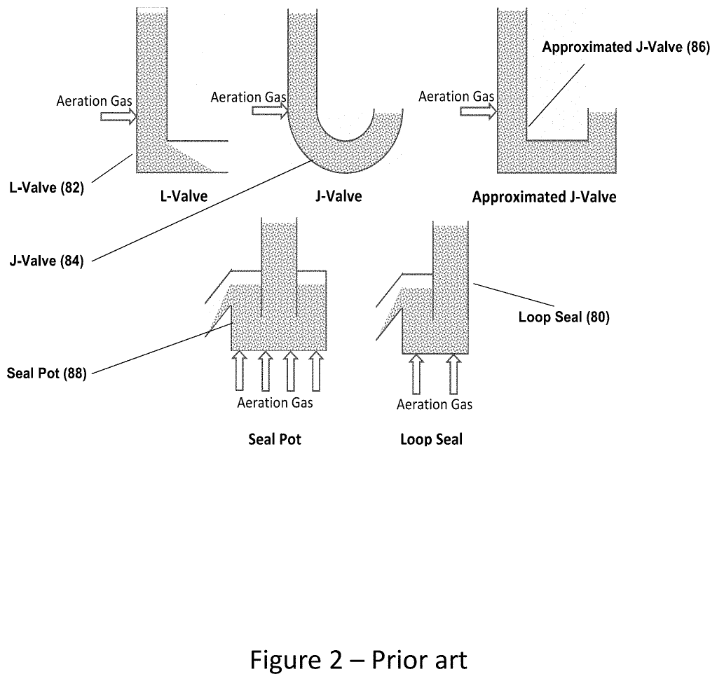

Every dual-bed gasifier system requires continuous circulation of higher temperature heat carrier (32) from the combustor (34) to the lower temperature gasifier vessel (36) and gas sealing between reducing conditions in the gasifier (36), and oxidizing conditions in the combustor (34). Non-mechanical valve and sealing devices, including loop seal, seal pot and various non-mechanical valves, have been previously taught, with some examples shown in schematic form in FIG. 2. The devices are generally used to prevent backflow of material and gas mixing, although they may also be used for monitoring or control purpose in some other cases.

As shown in the technical literature [1-4], non-mechanical devices have been in common use for many years. The present control system utilizes such non-mechanical devices, which may be of any known type, to control rate of flow of solids through the system in response to measured parameters, in order to optimize the operating conditions of the gasifier.

Although the present gasifier control system can be utilized with any one of these non-mechanical devices, for each type of non-mechanical device, a relationship between the pressure drop and the solids circulation, solids and gas properties, and the design features of the device must be understood. Each device has its advantages and disadvantages, with supporters and advocates as shown in Table 4 and mentioned in the discussion below.

In patents CA2842079, CA2842096, CA2842102, CA2843038, CA2843040 and CA2852761, incorporated herein by reference, seal pot, J-valve or L-valve are configured to prevent backflow of material in solids circulation.

In patent CA2852763, incorporated herein by reference, the function of seal pots and/or valves (e.g., L valves or J-valves) is for gas sealing, i.e., to maintain the pressure differential so that the product gas produced in a pyrolyzer does not contact the combustor flue gas or air from the combustor. Seal pots may be a more reliable seal method, which allows for steadier solid circulation and easier operation by reducing and/or eliminating undesirable unit pressure swings.

In patents CA2881239 and CA2750257, incorporated herein by reference, there are two dual bed systems in series, which means separated solid circulation loops for heat transfer material and for tar removal catalyst, respectively. Loop seals are used for both systems to transfer heat transfer material or catalyst from the bottoms of the gasifier or conditioner to the bottoms of the combustors.

TABLE 4
Dual-Bed Gasification System Patents Associate with Non-Mechanical Devices.

| | | Patent Name or | |
|---|---|---|---|
| | Patent Number | Shortened Subject | |
| Priority | (Filed Year) | Name | Assignee |
| US201161512365 | CA2842079 (2012) | Gasification system and | Res USA LLC |
| | CA2842096 (2012) | method | |
| | CA2842102 (2012) | | |
| | CA2843038 (2012) | | |
| | CA2843040 (2012) | | |
| US201161551582 | CA2852761 (2012)* | Gasifier Fluidization | Res USA LLC |
| US201161551580 | CA2852763 (2012)* | Seal Pot Design | Res USA LLC |
| U.S. Pat. No. 14,618,509 | CA2881239 (2010) | System and Method for | Res USA LLC |
| | CA2750257 (2010)* | Dual Fluidized Bed | |
| | | Gasification | |
| US201762483104 | CA3059374 (2018) | Integrated Biofuels | Sundrop Ip |
| | | Process Configurations, | Holdings LLC |
| US201762483115 | CA3059403 (2018) | Multi-Purpose | Sundrop Ip |
| | | Application of the | Holdings LLC |
| | | Second Stage of a 2- | |
| | | Stage | |
| US201762490891 | CA3060626 (2018) | First Stage Process | Sundrop Ip |
| | | Configurations in a 2- | Holdings LLC |
| | | Stage | |
| U.S. Pat. No. 38,191,710 | CA2810724 (2011) | Fluidised Bed Pyrolysis | University |
| | | Apparatus and Method | of Pretoria |
| CN201310316605.7 | CA2918168 (2014) | Method for Preparing | Eco Environment |
| | | H2-Rich Gas by | Energy Research |
| | | Gasification of Solid | Institute Ltd. Dalian |
| | | | University of |
| | | | Technology |

*The patent lapsed for failure to pay maintenance fees.

In patents CA3059374, CA3059403 and CA3060626, all incorporated herein by reference, a loop seal is used to ensure the safe injection of solids from the reactor cyclone system into the combustor and to ensure that gases from the combustor cannot mix with raw syngas. Downstream of the dual-bed gasifier, a densely packed moving bed of olivine, ilmenite or dolomite particles is designed to act as both a dust filter and a tar destroyer from the raw syngas. The moving bed treats the total syngas flow, and differs in purpose from the moving bed section in downcomers of the present Patent Application. In patent CA2810724, incorporated herein by reference, L-valves are configured between the combustion and pyrolysis zones for the circulation of hot particles from the combustion zone to the pyrolysis zone while preventing the flow of gas in the opposite direction. A Z-valve is also designed to allow for the unassisted transport of solids through the valve as only gravity is required as the driving force for the flow of solids. In patent CA2918168, incorporated herein by reference, the moving bed gasification reactor and pyrolysis reactor are configured to generate hydrogen-rich gas.

Challenges Addressed by the Present Invention

In practical gasifier operations, there are two challenges addressed by the present invention:
1) Instabilities caused by the process variables, e.g., biomass moisture content to gasifier, biomass feed rate, steam rate, etc.; prior art methods to address this include an increase or decrease of the solid circulation rate to bring the system to a new steady condition is a means in the system control strategy, instead of correcting actions at the source units (dryer, feeder, steam supply).
2) Instabilities caused by variations of solid circulation rate (or depressed solid circulation rate), e.g., too high a solids level in the downcomer standpipe causes the voidage at the bottom to decrease to a packed bed value i, and solid flow is impacted, pressure drop decreases or even turns from negative to positive, and requires increases to the aeration rate at the lower standpipe and loop-seal to bring the system back to its previous steady condition.

The present invention relates to instrumented vertical standpipes in the combustor cyclone downcomer and under a bubbling bed gasifier, operated in the moving bed flow regime in which regime the flow conditions and equations are well defined. Changes in pressure drop in other parts of the loop may also be monitored, through which in the presence of upsets or normal variations, the cause and location of the upset can be identified. The circulation can then be returned to its set-point or changed to a new set-point through changes to aeration gas flow to the non-mechanical devices. Calculations can then be done to determine any gas leakage due to lack of gas sealing, and conditions modified as necessary to ensure adequate gas sealing. These actions and their effects in restoring operations to the desired set points are illustrated in a series of pilot plant trials.

Through the addition of two instrumented test and control sections, preferably located in the combustor cyclone downcomer (58) and under the gasifier dense bed (40), operated in the moving dense bed flow regime, any number of upsets and problems with the recirculation flow can be diagnosed. Using non-mechanical devices (60) and (64), aeration gas can adjust circulation to bring the system rapidly back to its set points. Guided by fundamental knowledge of gas-solids flows, a control system for solids circulation can be constructed.

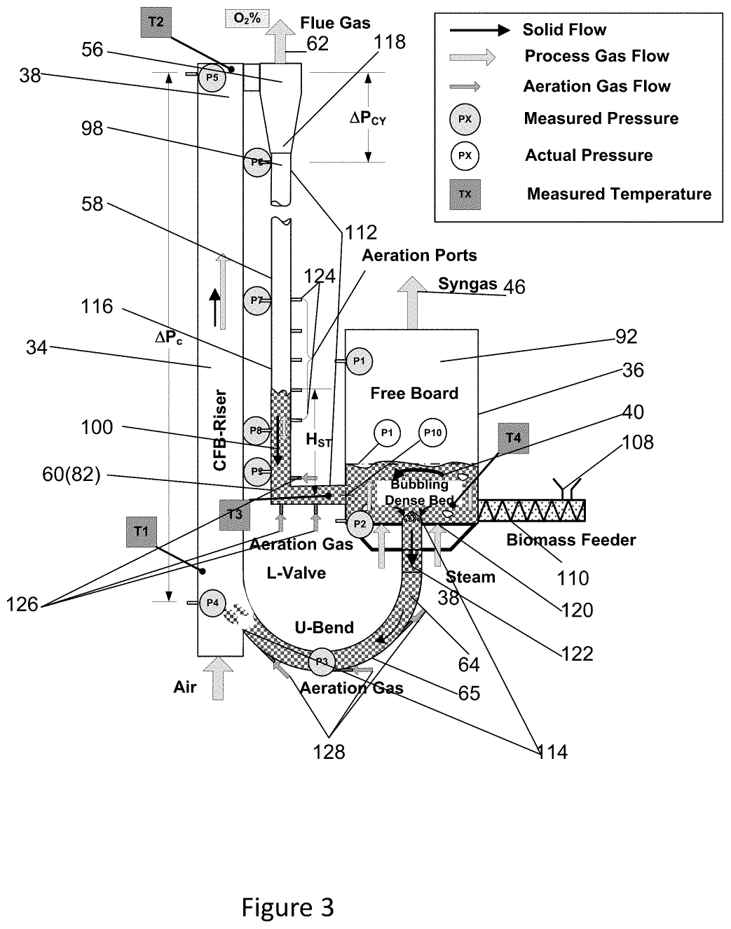

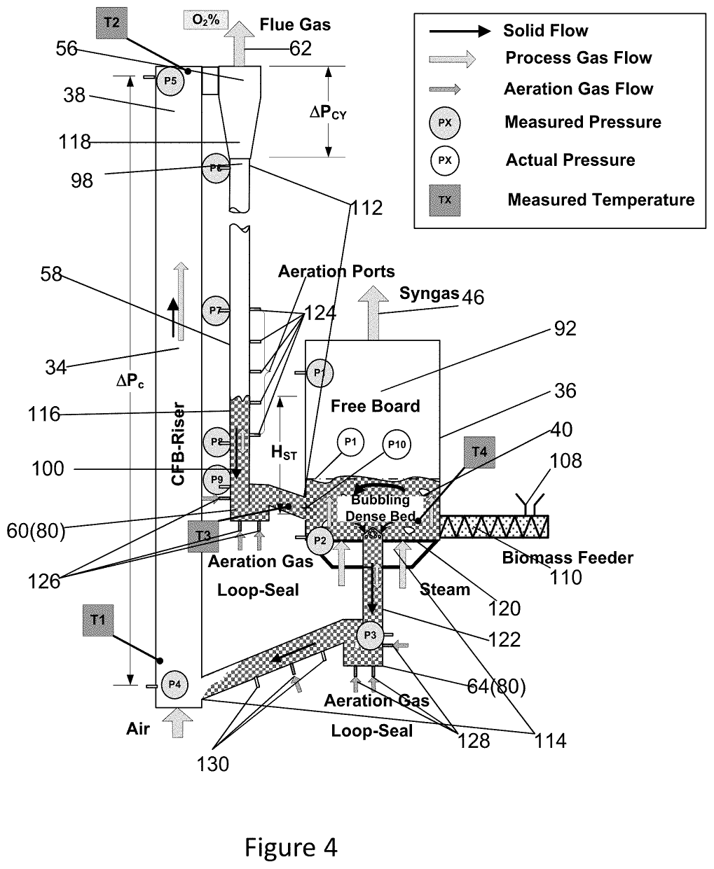

FIGS. 3 and 4 are schematics of two configurations of dual bed solid circulation systems of the present invention. Preferably pressures at about nine specific locations of the loop, and, in preferable embodiments, at least four temperatures, and two process and multiple aeration flow measurements are noted for an adequate control system. In both figures, the (yellow) filled pressure circles represent the measured pressures at the specified locations, and the white open pressure circles (P1 and P10) represent the actual pressures at the specified locations.

The solids circulation system is one continuous loop, consisting of two branches. The Upper Branch (112) consists of an overflow standpipe (116) fed from the CFB combustor cyclone bottom (118), with variable dense bed height in the downcomer (58). Its exit point in the BFB gasifier fluidized bed (40) should be significantly above the level of the grid (120), for pressure drop reasons. It is well instrumented along its length for diagnosis of potential operating problems.

The Lower Branch (114) comprises an underflow standpipe (122), with a non-restricted supply of solids from the BFB gasifier bed and a non-mechanical device (64), which is used for circulation control. Different types of non-mechanical devices are possible for varying the circulation, each with its own design features. As examples, strictly for illustration purposes, two different types of non-mechanical devices are shown in FIGS. 3 and 4, where the BFB gasifier (36) bottom is connected to the CFB riser (34) bottom: a U-bend (65) in FIG. 3, and a Loop-Seal (80) in FIG. 4. From the CFB cyclone downcomer (58) to the BFB gasifier dense bed (40), an L-valve (82) was used in FIG. 3 and a loop-seal (80) was used in FIG. 4. As would be understood to a person of skill in the art, any non-mechanical device could be used for either location.

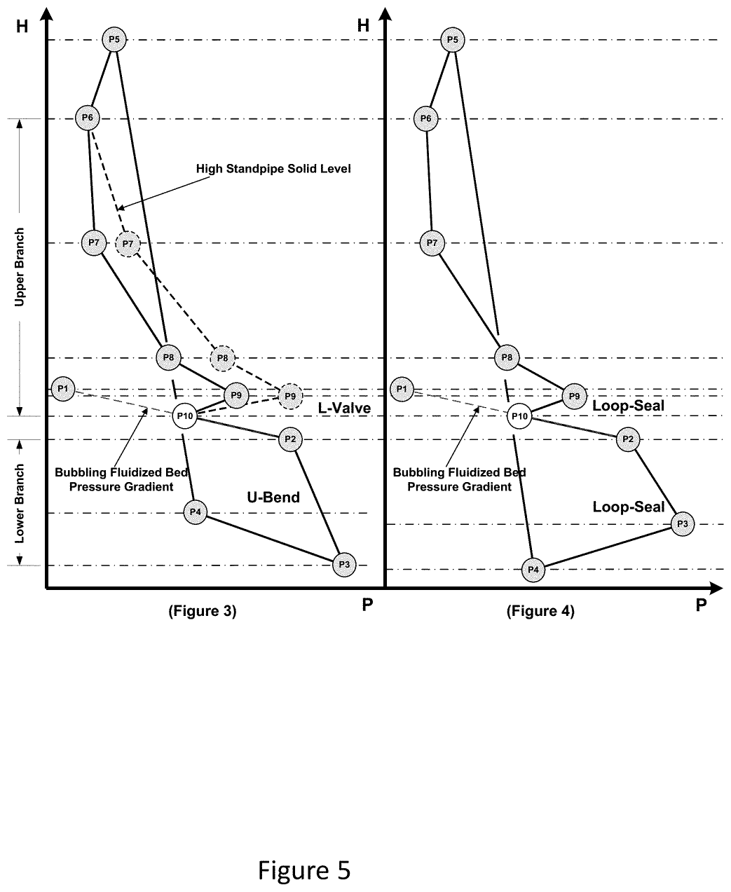

Table 5 shows the instrumentation required measurements for adequate system control. Table 6 lists the minimum recommended pressure and temperature measurements and specific locations in the solid circulation loop. Table 7 describes flow conditions and typical pressure drops of different sections at locations of FIG. 3 and FIG. 4. FIG. 5 shows the typical pressure profiles of FIG. 3 and FIG. 4.

In FIG. 3 and FIG. 4, P6 indicates the top of downcomer pressure, which is less than the riser top pressure (P5) by the pressure drop through the cyclone. P7 measures the upper of downcomer pressure. The preferred position for P7 measurement in the upper downcomer, is a location of sufficient distance from the bottom of the cyclone, and of high enough that it will be in the diluted section during the normal operation. It will serve as a guard position for the downcomer standpipe height. Pressure taps (not shown) and aeration ports (124) are located along the downcomer standpipe, the latter are of particular importance to counteract pressure effects where the standpipe is tall. The pressure difference between P7 and P6 is normally low at 0-0.2 kPa, in some cases, a small negative value could also be found (e.g., −0.2 kPa). A moving bed standpipe height is established with the pressure drop, ΔP_{ST}≈P9-P7, and the moving bed condition of the standpipe can be evaluated using the measured pressures P8 and P9 with defined distance at the bottom of the standpipe. If the dense solid level moves above the P7 measurement tap, the measured P7 value will increase and include the additional static head, indicating the increased height of the solids in the standpipe (see FIG. 5, dashed line pressure profile). Large pressure drop between P8 and P7 in dense moving bed condition with known distance, facilitates evaluation of the gas-solid flow condition of the downcomer middle section similar to the downcomer lower section.

As shown, nine (9) pressures (P1, P2, P3, P4, P5, P6, P7, P8, and P9) and four (4) temperatures (T1, T2, T3 and T4) are measured, though this is only a preferred embodiment. Measurements are performed utilizing temperature or pressure sensors (as appropriate) installed at the respective locations in the gasifier, and as shown schematically in FIGS. 3 and 4. As would be appreciated, the use of fewer sensors may still provide some advantage, and it has been found that measurements at P6, P7, P8 and P9 only would be sufficient to provide a fair amount of information for which to optimize gasifier parameters, for example. In other embodiments, for example where downcomer (58) is very tall (such as a typical commercial gasifier) it may be advantageous to have more than 9 pressure sensors, for example, a greater plurality of sensors at various locations within the downcomer (58).

With those temperatures' measurements, the thermal performance and the significance of the heat loss can be estimated. Controlled aeration gas flows (126, 128) at specified locations as shown in FIG. 3 and FIG. 4 form an important part and provide effective means in the solid circulation rate control and in maintaining a steady operation condition. Multiple aeration ports (124, 130) are reserved along the downcomer (58) and other solid flow sections, such as those in the loop-seal solid recycle inclined pipe (130) as shown in FIG. 4. A plot of height vs pressure indicates pressure gradients in the loop. The dashed line pressure profile as shown in FIG. 5 is an example, where the standpipe solid level is too high above the guard position of the P7 measurement.

TABLE 5
Instrumentation Required Measurements in FIG. 3 and FIG. 4

| Measurement | Location | Number |
|---|---|---|
| Pressure | P1-P9 | 9 |
| Temperature | T1-T4 | 4 |
| Biomass Flow | Gasifier Inlet | 1 |
| Steam Flow | Gasifier Inlet | 1 |
| Air Flow | Combustor Inlet | 1 |
| Flue Gas O₂% | Combustor Outlet | 1 |
| Aeration Gas Flow | Downcomer | 1-5* |
| | L-Valve/Loop Seal | 3 |
| | U-Bend/Loop Seal | 3 |

*Applied only in dense moving bed and dependent on standpipe height

TABLE 6
Minimum Recommended Pressure and Temperature
Measurements and Specific Locations

| Pressure | Temperature | Description | Comments |
|---|---|---|---|
| P1 | | Gasifier Free-Board Pressure | 1 |
| P2 | T4 | Gasifier Dense Bed Bottom Pressure | |
| | | and Temperature | |
| P3 | | U-Bend Middle or Loop-Seal Inlet | |
| | | Pressure | |
| P4 | T1 | Combustor Riser Bottom Pressure | |
| | | and Temperature | |
| P5 | T2 | Combustor Riser Top Pressure and | |
| | | Temperature | |
| P6 | | Downcomer Top Pressure | 2 |
| P7 | | Downcomer Upper Section Pressure | 3 |
| P8 | | Downcomer Lower Section Dense Bed | 4 |
| | | Pressure | |
| P9 | | L-Valve or Loop Seal Inlet Pressure | |
| (P10) | T3 | L-Valve or Loop Seal Exit Pressure | 5 |
| | | and Temperature | |

1: Measured at high position of gasifier free-board, equals to dense bed surface pressure
2: As a reference pressure for downcomer
3: Located in a position, where diluted fluidized condition is found in normal operation, sufficient distance from cyclone
4: Located in the dense bed with a distance from P9 to have appreciated pressure drop, e.g., ~0.5 m
5: P10 (not measured) specified from gasifier dense bed position, T3 measures actual heat carrier entering temperature

TABLE 7
Flow Conditions, Pressure Drops and Voidage in FIG. 3 and FIG. 4

| | | | | Typical | | Typical |
|---|---|---|---|---|---|---|
| Branch | Location | Description | Flow Condition | Pressure Drop | | Voidage |
| | P4-P5 | Combustor Riser | Fast Fluidized Bed | 0.35 | kPa/m | ~0.8-0.98 |
| | P5-P6 | Combustor Cyclone | Rotating Vortex | 2-5 | kPa | ~0.95-0.98 |
| Upper | P6-P9 | Combustor Downcomer Overall | | | | |
| Branch | P6-P7 | Downcomer Upper Section | Diluted Fluidized Bed | 0.1 | kPa/m | ~0.95-0.98 |
| | P8-P9 | Downcomer Lower Section | Dense Moving Bed | 6-10 | kPa/m | ~0.4-0.5 |
| | P9-P10 | L-Valve/Loop-Seal | Dense Moving Bed | 3-5 | kPa | ~0.4-0.6 |
| | P2-P1 | Gasifier Dense Bed | Bubbling Fluidized Bed | 12-14 | kPa/m | ~0.5-0.7 |
| Lower | P2-P4 | Gasifier Discharge to Combustor | | | | |
| | | Overall | | | | |
| Branch | P2-P3 | Gasifier Discharge to | Dense Moving Bed | 8-10 | kPa/m | ~0.4-0.5 |
| | | U-Bend Middle or Loop-Seal Inlet | | | | |
| | P3-P4 | U-Bend Middle or Loop-Seal Inlet | Dense Moving Bed | 8-10 | kPa/m | ~0.4-0.6 |
| | | to Combustor Bottom Inlet | | | | |

### EXAMPLES

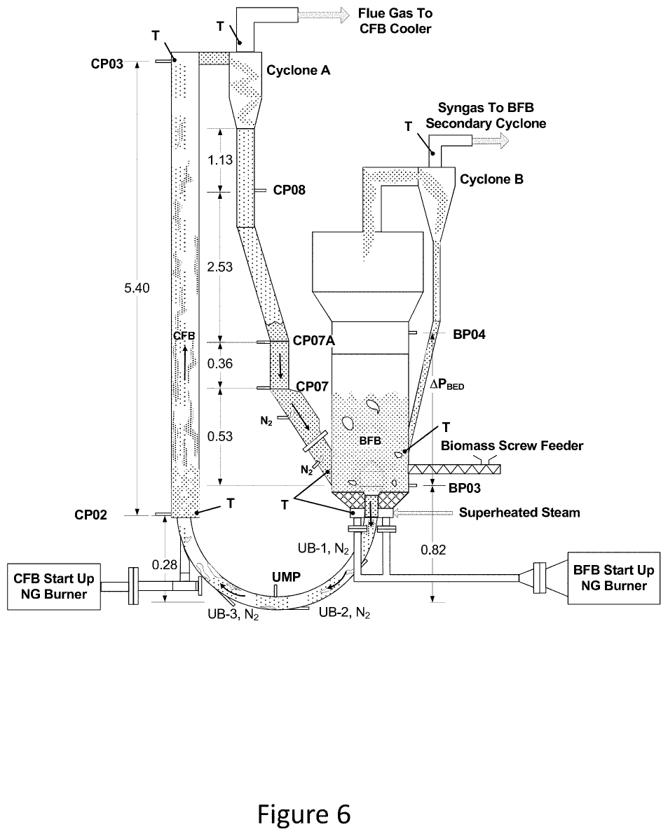

The Highbury-UBC Pilot Plant, and its performance as a gasifier have been described previously [7] (incorporated herein by reference). FIG. 6 shows the circulation loop and the associated pressure and temperature instrumentation.

Four Case Studies were undertaken, in which deviations from on-specification flow or temperature conditions were observed, and which illustrate how the teachings of this Patent application serve to identify and diagnose the problem, guide the control action to bring the system back to on-specification conditions.

Flow Description and Pressure Drops in On-Specification Operation

The Pilot Plant gasifier (as shown in schematic form in FIG. 6, and generally equivalent to the design shown in FIGS. 3 and 4, with different non-mechanical valve selection) was operated under conditions of steady state in the temperature range of 800-850° C., producing typical raw syngas. Under normal operation in gasification mode, typical readings of the identified pressure drops, and calculated pressure gradients were given in Table 8. For the subsequent experiments, the focus was on identifying upsets via the pressure drops around the flow loop, and taking control action to return conditions to those for steady state.

TABLE 8
Pressure Drops and Pressure Gradient of the Steady Pilot Dual Bed Gasification Operation

| | | Pressure Drop | Pressure Gradient | |
|---|---|---|---|---|
| Section of Loop | | ΔP (kPa) | ΔP/ΔL (kPa/m) | Conditions of Flow |
| Combustor Riser | CP02-CP03 | 1.72-2.02 | 0.32-0.37 | Fast Fluidization, |
| | | | | Gas-Solid Upflow, |
| | | Avg. 1.82 | Avg. 0.34 | High Gas Velocity, |
| | | | | High Voidage |
| Upper Downcomer | CP07A-CP08 | −0.02~0.22 | −0.01~0.09 | Diluted Fluidization, |
| | | Avg. 0.14 | Avg. 0.06 | Solid Downflow, Low |
| | | | | Voidage |
| Instrument Test | CP07-CP07A | 2.17~3.11 | 6.03~8.64 | Moving Bed |
| Section | | Avg. 2.50 | Avg. 6.95 | Solid Downflow, |
| | | | | εₚ < ε < ε_{mf}* |
| Lower Downcomer | BP03-CP07 | 3.23~3.63 | 4.82~5.40 | Moving Bed with Aeration |
| to Gasifier Dense B [symbol] | | Avg. 3.41 | Avg. 5.10 | Solid Downflow, |
| | | | | εₚ < ε < ε_{mf} |
| Gasifier Bottom | UMP-BP03 | 2.76~3.03 | 2.68~2.95 | Moving Bed with Aeration |
| to U-Bend Center | | Avg. 2.89 | Avg. 2.81 | Solid Downflow, |
| | | | | εₚ < ε < ε_{mf} |
| U-Bend Center to | UMP-CP02 | 4.35~4.79 | 9.15~10.1 | Moving Bed with Aeration |
| Combustor Inlet | | Avg. 4.63 | Avg. 9.73 | Solid Upflow, |
| | | | | εₚ < ε < ε_{mf} |

*εₚ vibrated packed bed voidage, ε_{mf} minimum fluidization voidage [symbol]
indicates data missing or illegible when filed

Table 8 indicates findings under typical gasification conditions with the U-bend aeration flow of about 9-12 L/min. These are considered to be on-specification typical average conditions. Comments on conditions within each section of the loop are given below:

Combustor riser [CP02-CP03]: In the combustor riser (34) operated in the fast fluidization regime, the gas-solid flow was a typical upflow with high voidage (ε>0.8˜0.98), the gas velocity was normally high at 4-10 m/s. The pressure drop was moderate at about 2 kPa, and a typical pressure gradient in the order of 0.3-0.4 kPa/m was found under the operation condition.

Upper downcomer [CP07A-CP08]: At the upper section of the downcomer (58), the gas-solid flow was in a diluted co-current fluidized condition, the solids flow down mainly under gravity and small upward drag forces. The voidage was high (e.g., ε>0.9). The pressure drop was small, ˜0.15 kPa, the pressure gradient is found to be low at ˜0.06 kPa/m. The moving bed solid may extend to this section, the pressure drop measured consists of two parts, 1) low pressure drop of the diluted fluidized bed above the CP07A, and 2) moving bed pressure drop. The pressure drop of the latter part should be closely monitored during the operation to prevent the continuing build up to the cyclone and then flooding, an operating issue caused when the particle discharge rate from the bottom end of the tube becomes smaller than the solids feed rate.

Instrumented test section [CP07-CP07A]: This test section (with the fixed height, 0.36m) was a typical cocurrent-cogravity solid downflow moving dense bed. The bed voidage was normally low at εₚ<ε<ε_{mf}. The pressure increases in the solid flow direction, the pressure drop was in the order of 2.5 kPa. The pressure gradient was high at about 7 kPa/m, but less than that at minimum fluidization, e.g., ρ_{ρ} (1-ε_{mf}) g,=2600*(1-0.45)*9.8=14.0 kPa/m.

Lower downcomer [BP03-CP07]: The lower downcomer section connected to the bottom of the gasifier dense bed transports the solids into the gasifier. The static head in the bubbling bed gasifier ensures a moving bed gas-solid flow condition, with a low voidage. The pressure increases in the solid flow direction under normal operation condition. The pressure drop was about 3.5 kPa, and the pressure gradient is in the order of 5 kPa/m.

Gasifier solid discharge to U-bend center [UMP-BP03]: From the bubbling fluidized bed gasifier bottom to the U-bend center with the aided aeration gas, the gas-solid flow was also a cocurrent-cogravity solid downflow moving bed. Under the steady operation condition, pressure increases in the solid flow direction. The pressure drop at the given aeration rate is in the order of 2.9 kPa, and the pressure gradient is approximately about 2.8 kPa/m.

U-bend center to combustor inlet [UMP-CP02]: From the U-bend center, aided by the aeration gas, the solids are fed to the combustor inlet at the riser bottom, where they are mixed with the combustion air and auxiliary fuel gas. The gas-solid flow continued from the upstream, becomes cocurrent-countergravity with the pressure decreasing in the solid flow direction. The pressure drop is about 4.6 kPa, and the pressure gradient is approximately 9.75 kPa/m.

Case Study Examples and Evaluation of Control Analyses

Values of pressure drop (or pressure gradient) in Table 8 were taken as Set-Points, since good, smooth operation was evident with these conditions. Results from several case studies in which different circulation-based “upsets” were explored using the Pilot Plant are summarized briefly in discussion of Table 9 through Table 12 below. It was determined that the upset could be detected, its location and probable cause identified, then control action was taken, and the dual bed gasifier returned to original set point conditions. Detailed descriptions of these tests with the raw data, and an interpretation of the results are provided in Appendix A.

In these four case studies, parts of the solid circulation system were purposely or accidentally upset from normal operation, affecting the circulation. Pressure drops throughout were compared with expectations (set points), and where discrepancies were found, actions were then taken to bring the system back to normal on-specification operation. These cases illustrate how the problem was identified, what part of the circulation loop was affected, the control action taken, and the outcome. Extensive mapping of the pressures was key to understanding what upset had happened, and how the dual bed system could be retuned to steady conditions.

Example Case 1: Gasifier Bed Temperature Decreasing. The experimental observation shows the continued decrease of the gasifier bed temperature from >850 to <810° C. (Appendix A), such that gasification would be quenched. Comparing the pressure measurements along the circulation loop (Table 9) with the “Set-Point values” in Table 8 indicates that, except for the pressure drop of CP07A-CP08, which was relatively higher, all the other pressure drops and pressure gradients were on the low side, and out of the ranges of Table 8. Particularly, the pressure drop of UMP-BP03 was found to be much (factor of 3.5) too low. Although many factors can give rise to gasifier bed temperature dropping, the above consistent deviations of pressure drop and gradient in the solid circulation loop suggested that the solid circulation rate was too low. By increasing the U-bend aeration gas rate from 9 L/min to 15 L/min, the pressure drop of UMP-BP03 increased from 0.83 kPa to 2.85 kPa, five of the six ΔP values moved closer to the set points. The gasifier temperature gradually stabilized at the desired 830° C.

TABLE 9
Case 1 Pressure Drops of the Solid Circulation Loop*
Case 1 - Low Gasifier Temperature
Causes - Low Solid Circulation
Correction - Increase U-Bend Aeration

| | U-Bend Aeration Flow (L/min) | | |
|---|---|---|---|
| | 9 | 15 | |
| Pressure Drop (kPa) | Before | After | Target |
| CP02-CP03 | 1.39 | 2.26 | 1.82 |
| CP07A-CP08 | 0.76 | 0.29 | 0.14 |
| CP07-CP07A | 1.92 | 2.70 | 2.50 |
| BP03-CP07 | 3.18 | 2.83 | 3.41 |
| UMP-BP03 | 0.83 | 2.85 | 2.89 |
| UMP-CP02 | 3.82 | 4.18 | 4.63 |
| Time | 19:30 | 20:00 | |

*Before refers to before corrective treatment. After refers to after corrective treatment.

### Example Case 1 Analysis

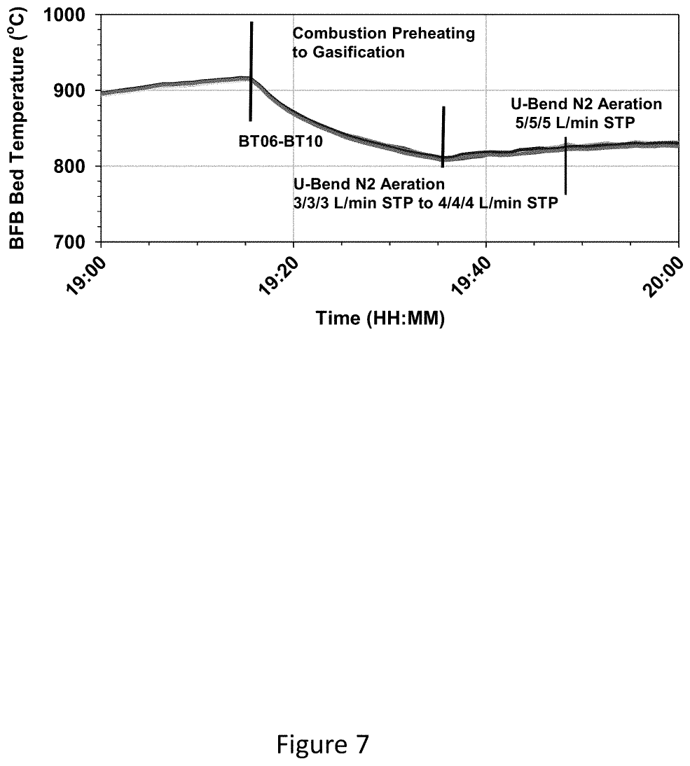

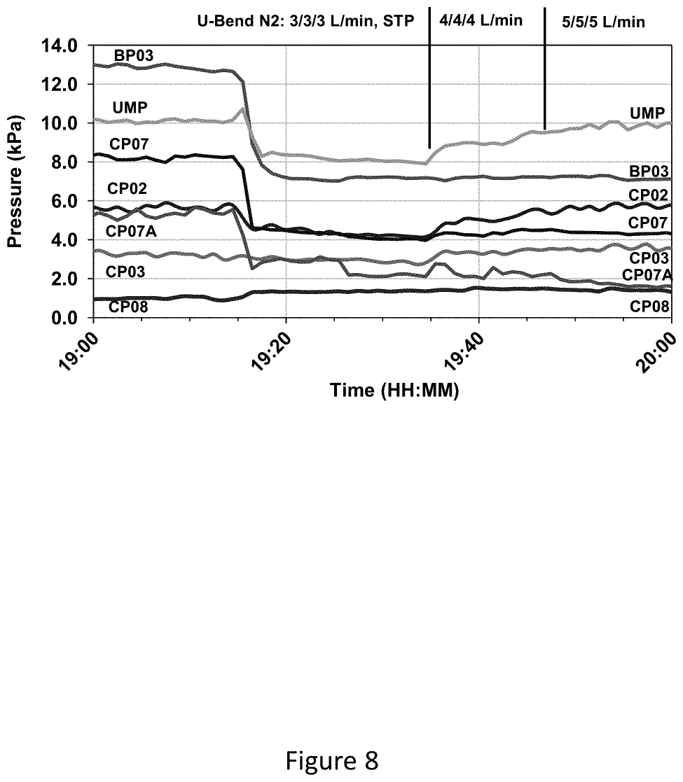

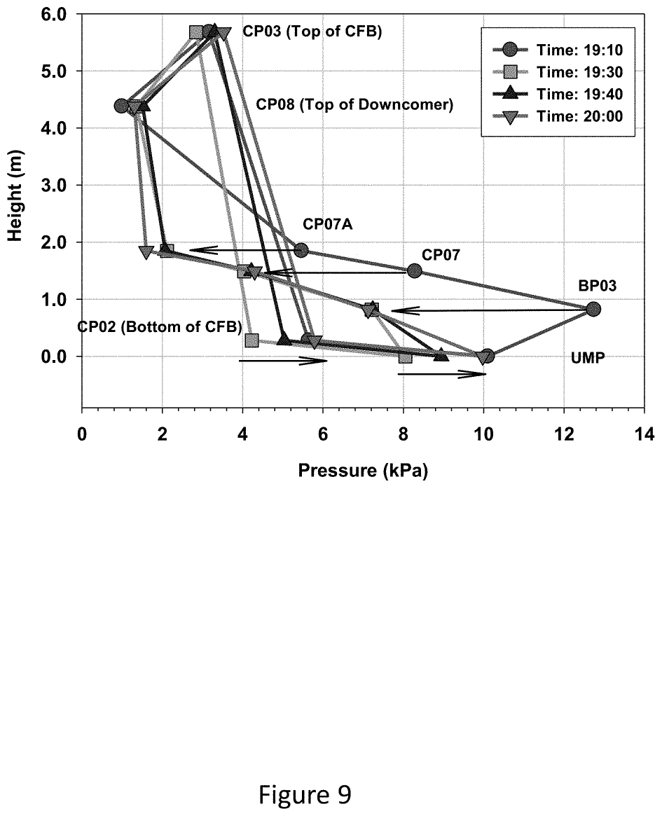

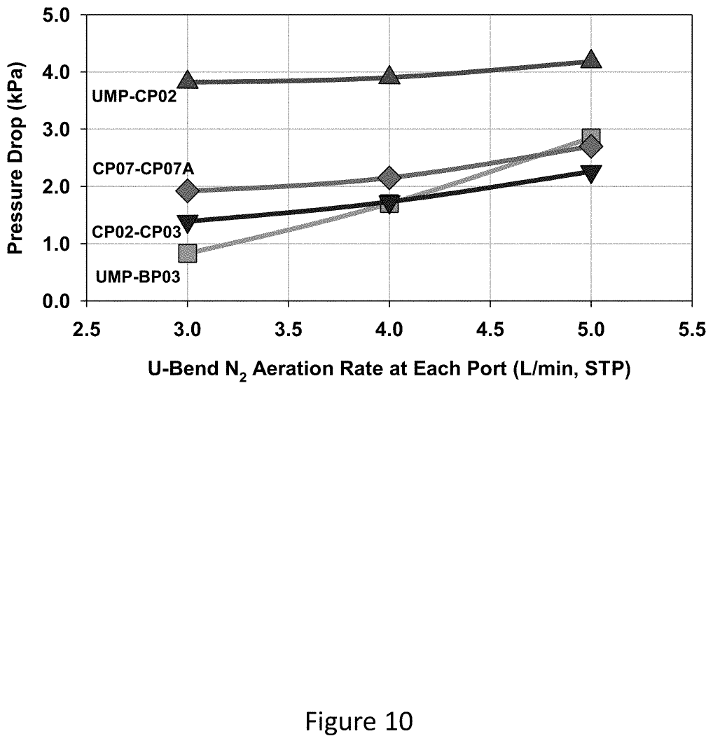

FIG. 7 shows the BFB bed temperatures during a transition period, for which the dual bed was switched from combustion preheating to biomass steam gasification. As shown in FIG. 7, following the switching from combustion preheating to gasification at about 19:15, BFB bed temperature started to decrease. The U-bend aeration gas rate was 3 L/min at each port during the preheating and switching to gasification. Decrease of BFB bed temperature indicates the thermal instability of the system, not enough hot solids to the BFB to thermally sustain the gasification reactions, and solid recirculation rate should be increased. At 19:35, the U-bend aeration rate was increased to 4 L/min, and the BFB bed temperatures started to increase. Later at 19:47, the U-bend N₂ aeration rate was further increased to 5 L/min, and the BFB bed temperatures were gradually stabilized at about 830° C. FIG. 8 shows solid recirculation loop pressures during this period. Following the switch-over, the BFB bottom pressure, and the pressures in the CFB downcomer low sections connected to the BFB (CP07, and CP07A) took a jump to a low level, e.g., BP03 was decreased from about 13 kPa to about 7 kPa. FIG. 9 plots the solid recirculation loop pressures vs. height at specific times. As shown in FIG. 9, only slight changes were found for the CFB top pressure, CP03, and the downcomer top pressure, CP08 during the switch-over operation. The newly established pressure balance and gas solid recirculation (green colored) could not be able to sustain the thermal demand of the gasification. Following the increase of the U-bend aeration rate, significant changes (increases) were observed for U-bend middle and CFB bottom pressures, UMP and CP02, while other pressures remained relatively unchanged, e.g., BP03. Table 10 lists the pressure drops along the solid recirculation loop during the gasification at three times, with different U-bend aeration rates. Except the pressure drop between the BFB and CFB bottom, BP03-CP02, other pressure drops show the increase with increasing N₂ aeration rate, which are plotted in FIG. 10. As shown, the pressure drop of UMP-BP03 is the most sensitive pressure drop in responding the changes of N₂ aeration rate and solid recirculation rate as well. A small pressure drop between CP07A and CP08 indicates a diluted fluidized bed existing above the CP07A, aeration in the low section of the downcomer did not need to be adjusted under this condition.

TABLE 10
Pressure Drops along the Solid recirculation Loop with Different U-bend Aeration Rates

| | N2 Aeration | BP03-CP02 | UMP-BP03 | UMP-CP02 | CP02-CP03 | CP07-CP07A |
|---|---|---|---|---|---|---|
| Time | *L/min | kPa | | | | |
| 19:30 | 3 | 7.10 | 0.83 | 3.82 | 1.39 | 1.92 |
| 19:40 | 4 | 2.20 | 1.70 | 3.90 | 1.73 | 2.15 |
| 20:00 | 5 | 1.33 | 2.85 | 4.18 | 2.26 | 2.70 |

*at each port, STP

### Example Case 2: Cold Solids Injection into Downcomer

An upset of the steady solid circulation was caused by a surge in cold make-up sand injection at the CP07A position. Table 11 shows the pressure drops along the circulation loop at two specific times. During the disturbance, the gas-solid flow in the downcomer test section turned into a cocurrent-cogravity solid downflow compacted by the downward flow drag with the lowest voidage and negative pressure drop of CP07-CP07A. With the impacted solid flow, the pressure drop of the following section (BP03-CP07) is also lowered. Both of the pressure drops in the U-bend sections (BP03-UMP) and (UMP-CP02) were not affected, suggesting that the original solid flow rate was maintained. Consequently, the downcomer dense bed height increased, resulting in a high pressure drop in the section (CP07A-CP08) due to the backup of solids. From Table 11, the pressure drops of solid circulation loop are within the ranges of those values in Table 8 after the cold sand injection disturbance ceased, and the gas-solid flow in the test section recovered to the preferred condition, i.e., solid downflow and pressure increase in the solid flow direction.

TABLE 11
Case 2 Pressure Drops of the Solid Circulation Loop
Case 2 - Downcomer Dense Bed Height Increase
Causes - Colid Sands Injected at CP07A
Correction - Injection Stopped at 20:30

| Pressure Drop (kPa) | Before | After | Target |
|---|---|---|---|
| CP02-CP03 | 2.11 | 2.29 | 1.82 |
| CP07A-CP08 | 3.96 | −0.13 | 0.14 |
| CP07-CP07A | −0.79 | 2.40 | 2.50 |
| BP03-CP07 | 2.32 | 2.88 | 3.41 |
| UMP-BP03 | 3.10 | 3.27 | 2.89 |
| UMP-CP02 | 4.19 | 4.13 | 4.63 |
| Time | 20:30 | 22:00 | |

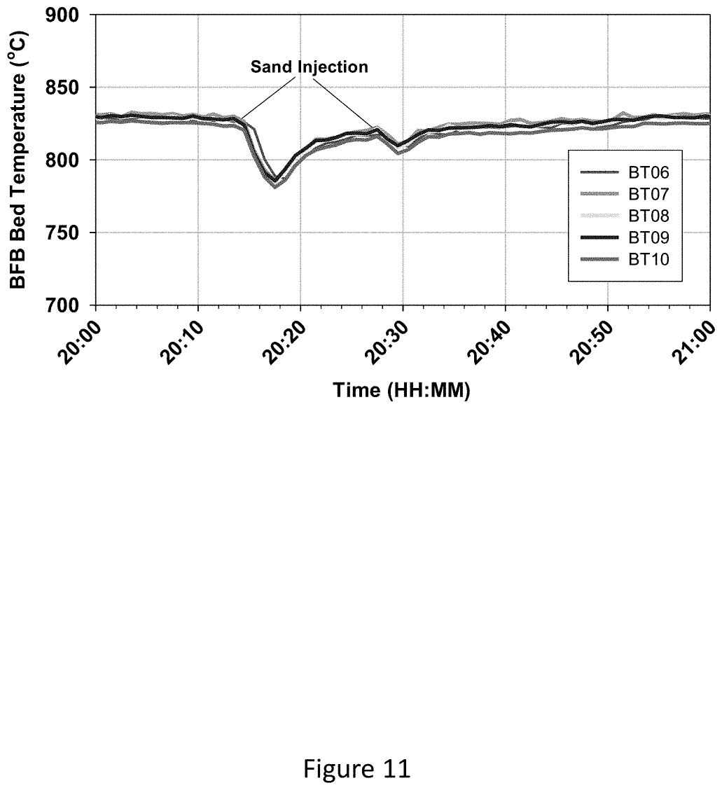

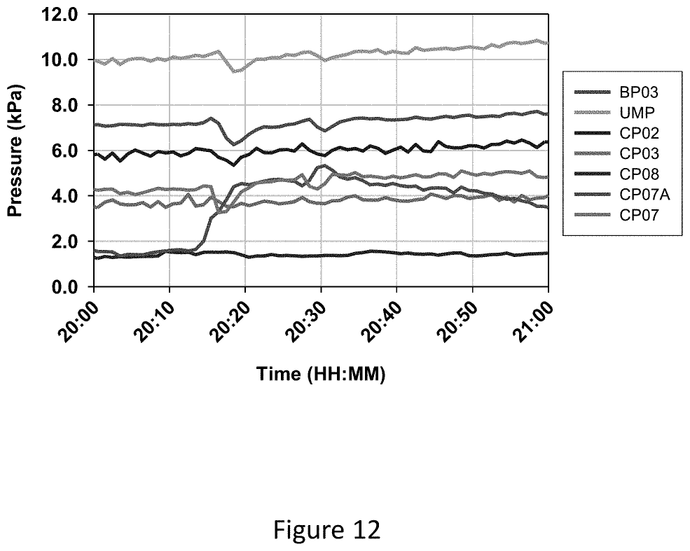

FIG. 11 and FIG. 12 show the BFB bed temperatures and pressures variations caused by a disturbance from downcomer at CP07A after addition of cold sand. Sand loss from the CFB cyclone to downstream at about 5-6 kg/h was found during the pilot experimental runs, which caused the gradually decreased BFB bed height, then the bed pressure, BP03. To compensate the decrease of the BFB bed height, maintain a relative stabilized BFB bed pressure, sand injection was conducted during the operation from an available 21 mm port at CP07A position with hopper above a ball valve.

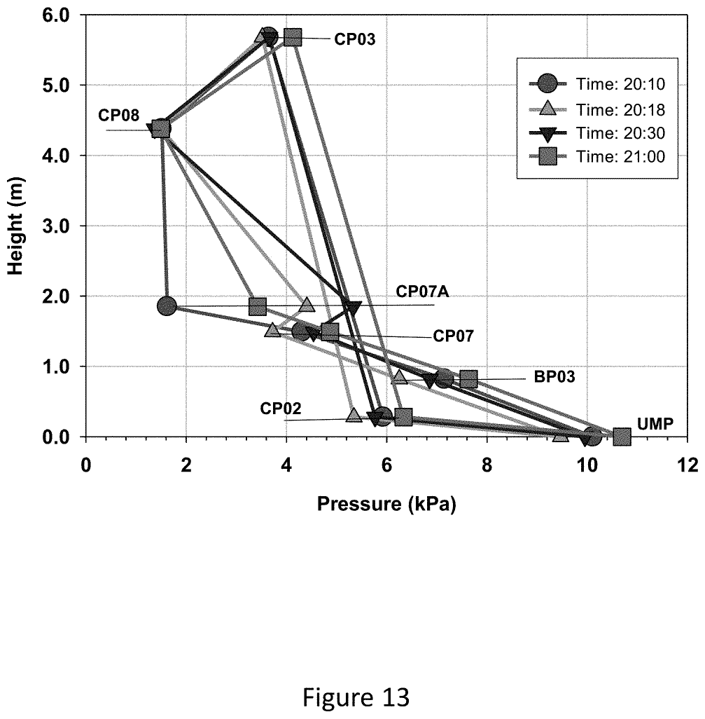

As shown in FIG. 11, cold sand injection at 20:15 and 20:27 with the total amount about 5 kg caused the BFB bed temperature decrease up to almost 60° C., and took about 5 minutes to be heated back to a lower level. The effects of this disturbance on the solid recirculation loop pressures are shown in FIG. 12. Along the solid recirculation loop, the pressures at CP07, BP03, UMP and CP02 show similar decreases as the bed temperatures, the pressure of the downcomer top, CP08, was not affected. However, the pressure at CP07A, i.e., 36 cm above the CP07 position, shows an increase, higher than that of CP07. FIG. 13 shows the solid recirculation loop pressures at four specific times: 20:10, before the sand injection, 20:18 and 20:30 during the disturbance, and 21:00, after the disturbance.

From the gas-solid flow patterns of solid recirculation loop analysis, it is understood that there exist two different gas-solid flow patterns in the CFB downcomer. In the upper section, the gas-solid flow is in the diluted fluidized condition, i.e., solid falls downward mainly under gravity and small upward drag forces, the voidage is high in this section. In a normal condition, the pressure drop was observed to be small, i.e., pressure slightly increases in the downward direction, as shown by the data of 20:10 in FIG. 13. A moving bed gas-solid flow section exists at low section of CFB downcomer, i.e., the section below the CP07A, the solid moves downward co-currently with entrained gas flow as described previously. The slip velocity is upward and the pressure increases in the downward direction (negative pressure drop). The established gas-solid moving bed has the characteristics of downward particles partially supported by flow drag and voidage between ε_{mf} and εₚ (vibrated packed bed voidage). This gas-solid flow pattern is necessary to maintain a steady solid recirculation and gas seal between CFB flue gas and BFB syngas.

Injection cold sand from the CP07A position disturbed the above established steady condition. Cold sands under the gravity force enter the section meet with hot sands which were moving down with a specific velocity, both cold solid and interstitial gas were quickly heated up when entering the section. Increased gas volume altered the previous gas-solid flow pattern. Much increase of gas velocity could be expected, and a downward negative slip velocity was resulted, and therefore pressure is decreased in the downward direction (positive pressure drop) as shown by pressures of CP07 at 20:18 and 20:30 in FIG. 13. The moving bed has the characteristics of downward particles compacted by the flow drag and tend to arrange themselves to the voidage of the vibrated packed bed, εₚ, therefore, the downward solid velocity decreases.

Coexistence of solid downward moving bed sections above CP07A and below CP07 is indicated by the pressure drops of CP07A-CP08, and BP03-CP07 as shown in FIG. 13. The pressure drops between CP07A-CP08 were significantly increased from a previous low value (0.11 kPa at 20:10) to the high values (2.90 kPa-3.96 kPa), suggesting that the moving bed height is extended to a high position above the CP07A position. The exact height is unknown since there is no pressure transducers installed in the downcomer between CP07A and CP08. On the other hand, the gas-solid flow patterns immediate below the upper diluted fluidized section and below the CP07 to the BFB entrance are similar to the low section (CP07A-CP07) before this disturbance, i.e., actual solid downward velocity is larger than the downward gas velocity based on the observed pressure drops. Therefore, the moving bed height above the CP07A would be expected to be proportional to the pressure drop of the CP07A-CP08, even though the boundary of the different moving bed section is not clear.

Since the BFB bed temperature after the second small amount cold sand injection gradually increases and approaches a stabilized condition, no operational intervention was conducted, and a 5 L/min STP N₂ aeration at the low position of downcomer was kept no change for this disturbance, the downcomer gas-solid flow was slowly recovered as seen in FIG. 12 that the pressure of CP07A is decreased slowly upon decrease of the bed height above CP07A, and the gas-solid moving bed has returned back to the positive slip velocity with the voidage εₚ<ε<ε_{mf}. After the above experience, the cold solid injection position was changed to a different location to avoid such disturbance.

### Example Case 3: Prevention of CFB Cyclone Flooding by Solid Accumulation in CFB Downcomer

A near cyclone flooding situation had been developed in the downcomer caused by too high a dense bed and lack of sufficient aeration gas. Table 12 gives the pressure drops measured during this case. The very high pressure drop of CP07-CP08 Before Correction indicates that a dense bed solid was built up to a high position in the upper downcomer; the abnormal (negative) pressure drop of BP03-CP07 in the lower downcomer illustrates the impacted solid flow of solid circulation loop. Increase of the aeration gas in the lower downcomer counteracted the compression effect, reversed the negative pressure direction, increased the voidage and improved the solid fluidity in this section.

TABLE 12
Case 3 Pressure Drops of the Solid Circulation Loop
Case 3 - Potential Cyclone Flooding
Causes - Too High Dense Bed, Insufficient Aeration
Correction - Increase Aeration Gas to Lower Downcomer

| Pressure Drop (kPa) | Before | After | Target |
|---|---|---|---|
| CP02-CP03 | 3.06 | 3.11 | 1.82 |
| CP07A-CP08 | 6.82 | 3.79 | 0.14 |
| CP07-CP07A | 2.31 | 2.95 | 2.50 |
| BP03-CP07 | −0.50 | 2.06 | 3.41 |
| UMP-BP03 | 3.00 | 3.04 | 2.89 |
| UMP-CP02 | 4.81 | 4.84 | 4.63 |
| Time | 1:30 | 2:00 | |

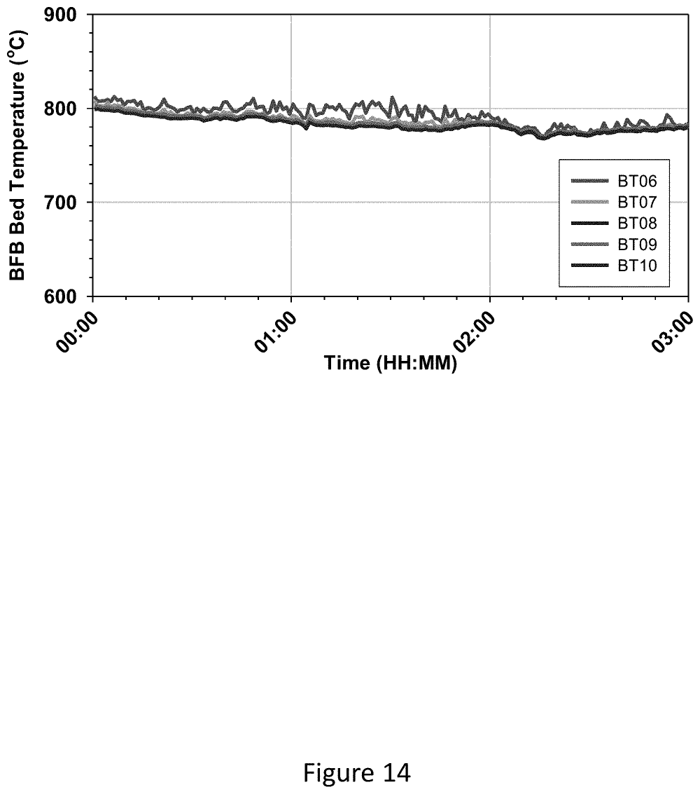

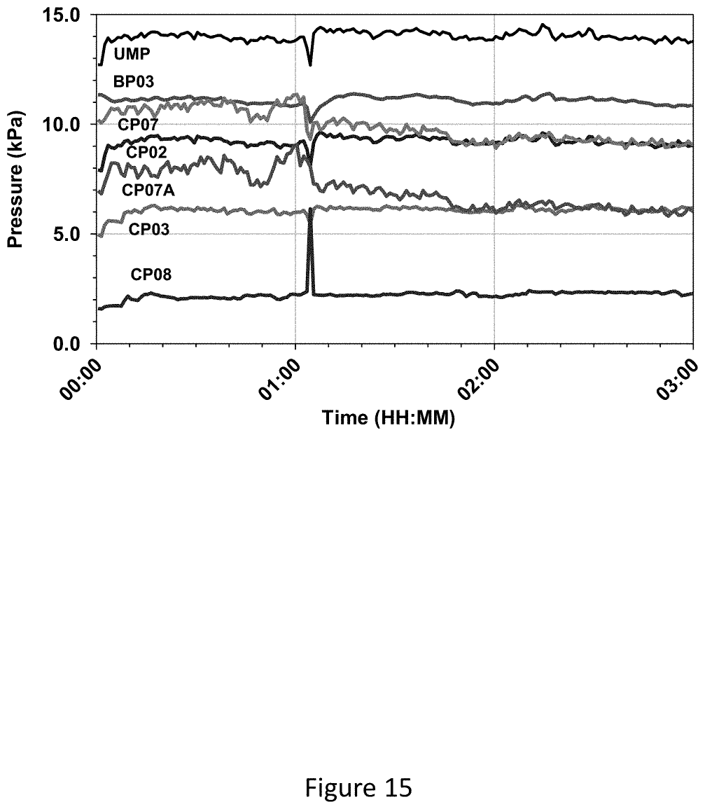

FIG. 14 shows the BFB bed temperatures over three hours during gasification stage from an experimental run. The bed temperatures were relatively low (<800° C.) compared to other runs. FIG. 15 shows the solid recirculation loop pressures, a U-bend N₂ aeration of 3/3/3 L/min STP was used. Based on the relatively constant pressure drops between BP03-UMP (avg. ΔP=−2.9 kPa) and CP02-CP03 (avg. ΔP=3.2 kPa), the solid flow rate from the BFB bottom through the CFB riser would be quite stable over the three hours gasification period. It can be noted from FIG. 15, the pressures at CP08 showed a strong peak at 1:05, and other pressures also shows corresponding changes. In the previous cold tests, it happened that the sudden increase of CP08 pressure during the solid recirculation will be followed by a CFB cyclone flooding. It was found that the sands were piled up in the downcomer up to the CFB cyclone, and the sands from the riser will flow directly to downstream, and BFB bed height will decrease quickly until all the sands are lost. The CFB cyclone flooding presents high risk during the dual bed operation, and the consequences would be fire hazard and the plant shut down. To respond to this event, N₂ aeration at two ports in the low end of the downcomer was used, 3 L/min for the upper one and 6 L/min at the bottom one (near the BFB entrance). After applying the two N₂ aerations, CP08 was quickly decreased to the previous low value (˜2 kPa), a CFB cyclone flooding situation was avoided, and detailed analysis will be given below:

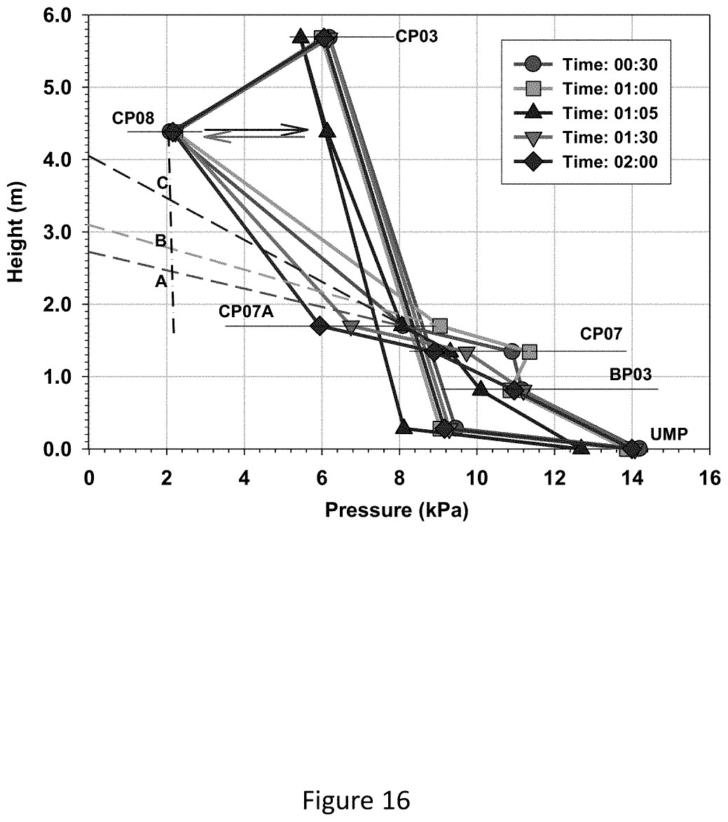

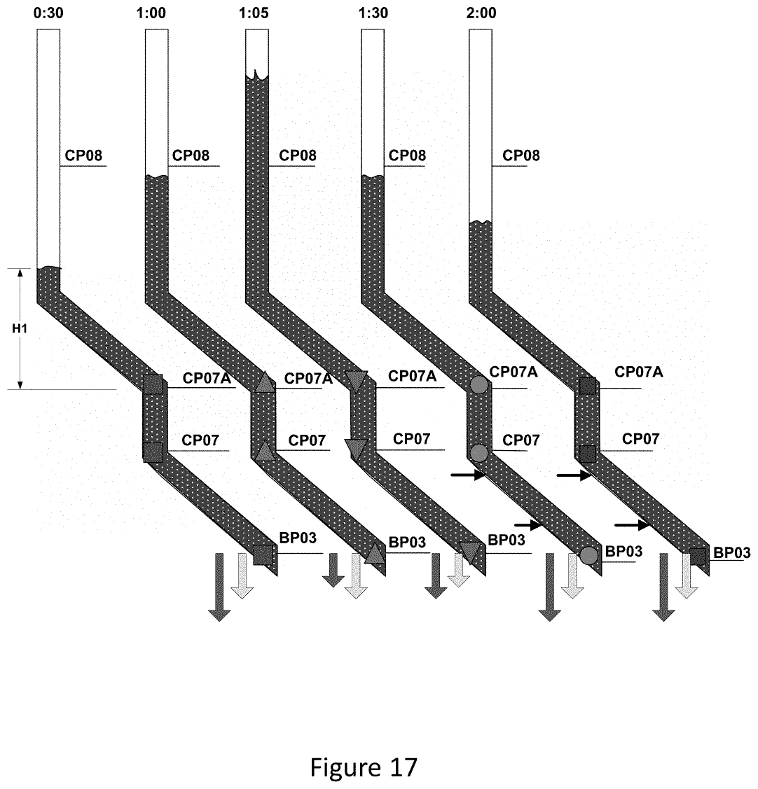

FIG. 16 plots five sets of loop pressure vs the height at specific times including the one at 1:05. From the two sets of the loop pressure prior to the one at 1:05, abnormal pressure profiles have already existed in the low sections of the downcomer: both CP07 and CP07A pressures are high, the pressure drop CP07A-CP08 was very high, about 6 kPa and 7 kPa at 0:30 and 1:00, respectively. At 1:00, a negative pressure drop between BP03 and CP07 was resulted, suggesting that the flow pattern has changed for this section as described previously with the downward slip velocity. The pressure drop between CP07 and CP07A was quite constant (˜2.8 kPa), suggesting that solids are steady moving down through this section. FIG. 17 shows schematics of the downcomer solid moving bed situations at different times.

From gas-solid flow patterns and previous case analysis, it was understood that high pressure drop between CP07A-CP08 at the downcomer upper section suggests the moving bed height is extended to a higher position above CP07A. CP08 is located at upper position 1.13 m below the CFB cyclone. If the moving bed top surface is below the CP08 and there is still a diluted fluidized section between the moving bed top surface and CP08, and if this section could be assumed to be the same moving bed flow pattern as the section CP07-CP07A, the intersections of the extended dash lines of the CP07-CP07A in FIG. 16 (A, B and C) would give the moving bed top surface pressure and the height, in which the slightly inclined dash line represents the dilute fluidized section pressure drop vs. height for approximation. For example, the position A can be estimated as H1(0:30)=ΔP (07A-08)/[ΔP/H (07-07A)]=6.01/7.80=0.77 m. From the intersection positions (A and B in FIG. 16) and solid surface levels in FIG. 17, it is seen that the top surface position is moved up from 0:30 to 1:00.

At 0:30, the pressure drop of the followed section, CP07 to BP03, shows the problem of the smooth solid circulation. The pressure drop ΔP (BP03-CP07)=11.2−10.9=0.26 kPa, if ignoring the inclined section effect, the vertical length is about 0.53 m, so the pressure drop per length of the vertical height is only 0.26 kPa/0.53 m=0.482 kPa/m, which is too small compared to the above sections. The pressure drop per length in a solid moving downflow bed is approximately proportional to the slip velocity, Uₛₗ,{Ergun Equation, ΔP/ΔL≈K U_{Sl}, at Re <20, K=150*[(1-ε)/ε]²*μ_{g},/(φdₚ)²} and Uₛₗ=U_{g}−Uₛ, where U_{g} and Uₛ are the actual gas and solid velocities, respectively, related to the superficial velocities by U_{g}=U⁰_{g}/ε and Uₛ=U⁰ₛ/(1-ε). As shown in FIG. 16, pressure increases in the downcomer from the top of the moving bed to the low position of P07. It is known that increase of pressure decreases the voidage of the moving bed due to the compression effect, and the Ergun Equation is very sensitive to the bed voidage. Therefore, the decrease of the pressure drop could mainly be due to the decrease of voidage by the increase of the pressure along the standpipe. The solid flow rate is expected to be decreased in this section. The above observation indicates that the maximum height of the moving bed should be limited if there is no aeration gas added.

Since there is no operational intervention, the situation in the downcomer continues. With the stable solid supply rate from upstream (constant pressure drops across BP03-UMP, UMP-CP02, CP02-CP03), the moving bed height above CP07A keeps increasing.

At 1:00, both pressures of CP07A and CP07 keep increasing, from 8.10 kPa to 9.15 kPa, and from 10.9 to 11.4 kPa, respectively. The pressure drop of ΔP (07-07A)=2.31 kPa, or ΔP/ΔH=6.41 kPa/m, slightly lower than the previous value. Similarly, the height of the H1 above the CP07A can be estimated: ΔP (07A-08)=9.05−2.22=6.82 kPa, H1(1:00)=ΔP (07A-08)/[ΔP/H (07-07A)]=6.82/6.41=1.06 m. It is seen that the moving bed height has increased from 0.77 m to 1.06 m due to the solid flow restriction in the downstream section CP07-BP03. Since the pressure BP03 depends on the bed height of the gasifier, the level in the gasifier is less sensitive than the level in the downcomer standpipe, so that the BP03 is kept relatively constant. As shown in FIG. 16, the gas-solid flow pattern in the section of CP07-BP03 has been changed from the previous positive slip velocity to a negative slip velocity. Due to the high pressure of CP07 developed, the actual downward gas velocity is larger than the actual downward solid velocity, solids move down under gravity and downward fluid drag forces, the bed voidage is decreased to the minimum value of the vibrated packed voidage, cₚ. Consequently, the moving bed height above the CP07A increases.

From the subsequent loop system pressure drops and from the slopes of the downcomer (blue lines of CP08-CP07A, CP07A-CP07, CP07-BP03), a certain extent of the solid downward moving was regained. The gas-solid flow in the section of CP07-BP03 then returned from a positive to a negative pressure drop.

After introducing aeration gas 3 L/min and 6 L/min at two locations as shown, the voidage in the low moving bed section increased, and the solid fluidity and flow rate increased; the height of the moving bed above CP07A decreased. A stable solid downward flow is gradually recovered as the similar slopes of the downcomer in FIG. 16, from CP07A to BP03.

Based on the above analysis, the moving bed height should be closely monitored during solid recirculation. Additional pressure transducers and aeration ports in the downcomer upper section can provide early warning of such events.

### Example Case 4: Misposition of the Flapper inside Trickle Valve Causes Restriction at the Low End of Downcomer, Creates CFB Cyclone near Flooding Situation

A solid flow restriction was identified in the low downcomer, resulting in an increased dense bed height in the upper downcomer. The measured pressure drops (Table 13) showed a very high pressure drop in the upper downcomer (CP07A-CP08) , low pressure drops in the lower downcomer (CP07-CP07A, BP03-CP07) and even a negative pressure drop in the solid discharge section (UMP-BP03). On removal of the blockage, the negative pressure was reversed, and other ΔP values moved partially towards set point values. If no correction had been applied, the consequence would be cyclone flooding, as in Case 3.

TABLE 13
Case 4 Pressure Drops of the Solid Circulation Loop
Case 4 - Backup of Lower Downcomer
Causes - Restriction of Flow in Lower Downcomer
Correction - Removed Restriction

| Pressure Drop (kPa) | Before | After | Target |
|---|---|---|---|
| CP02-CP03 | 1.34 | 1.45 | 1.82 |
| CP07A-CP08 | 6.35 | 2.32 | 0.14 |
| CP07-CP07A | 0.14 | 3.48 | 2.50 |
| BP03-CP07 | 0.59 | 2.35 | 3.41 |
| UMP-BP03 | −0.57 | 0.29 | 2.89 |
| UMP-CP02 | 3.25 | 4.36 | 4.63 |
| Time | 17:18 | 18:00 | |

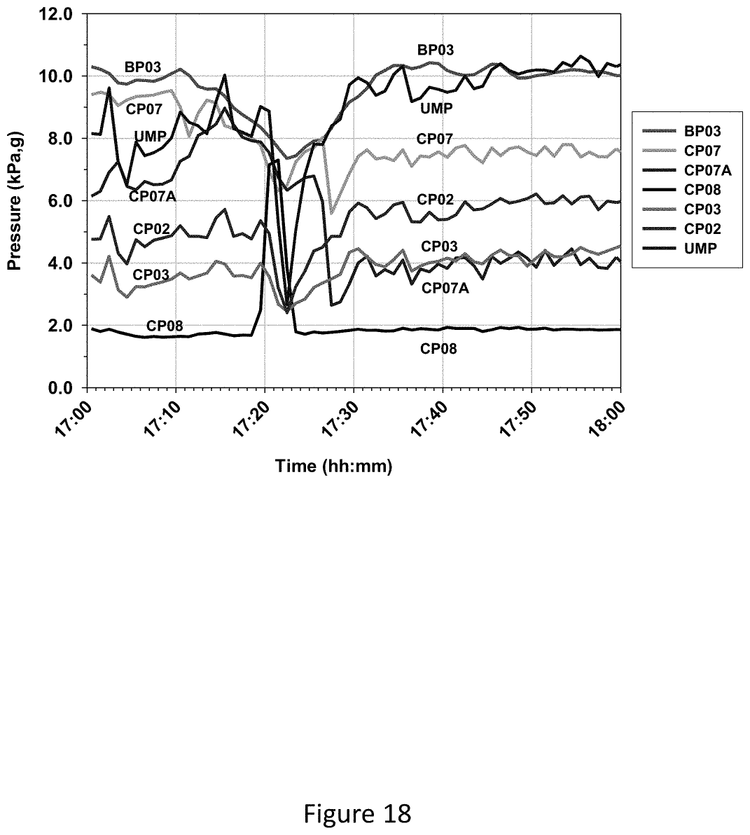

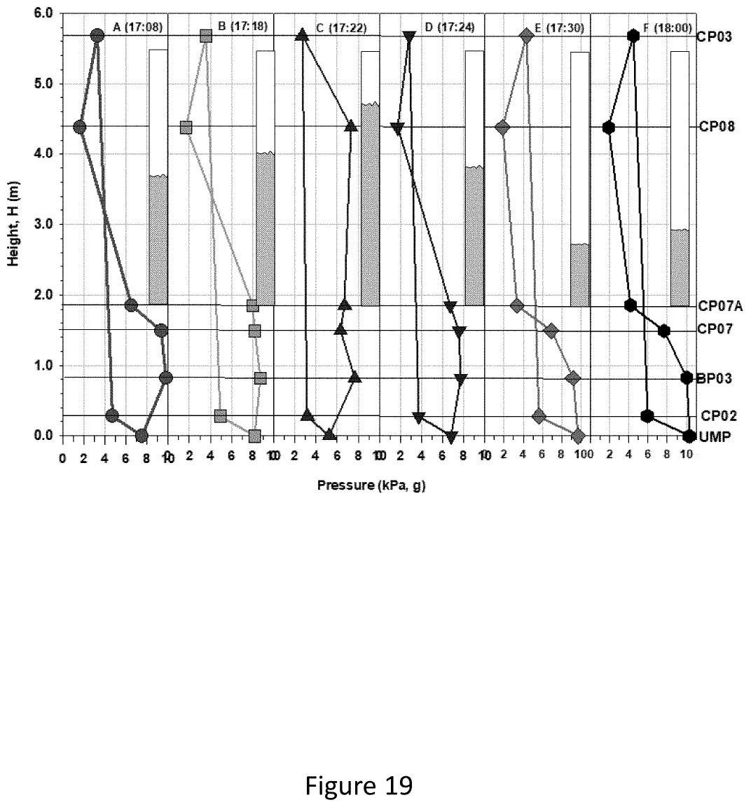

FIG. 18 shows the pressure profiles of one-hour solid recirculation during the gasification stage. The positions of the pressure measurements in the solid recirculation loop at specific times are shown in FIG. 19 (A, B, C, D, E, F) with schematic solid height drawn in the section CP07A-CP08. As shown in FIG. 19(A) for the pressure profile at 17:08 (red line loop), both pressures of CP07 and CP07A (upper end of CFB cyclone downcomer 36 cm vertical section) are high at 9.4 kPa and 6.5 kPa, respectively, and with differential pressure of about 2.9 kPa. The differential pressure of CP07A-CP08 is high at 4.9 kPa, suggesting that the dense moving bed section is extended to a high position above CP07A. A small pressure drop is observed between CP07 and BP03, where there is an about 53 cm height of moving bed section at the entrance of the BFB, and with a considerably low upward slip velocity.

The N₂ aerations at U-bend were fixed at 4/4/4 L/min, and the differential pressure CP02-CP03 represents approximately the solid recirculation rate. At 17:18 after the system was running for 10 mins, gasifier bottom pressure, BP03, decreased from about 10 kPa to 8.5 kPa, at a rate of about 12 kPa/h, significantly higher than that due to system sand loss from CFB cyclone to downstream (1 kPa/h). The downcomer upper end pressure, CP07, follows a similar drop as for BP03. On the other hand, the pressure at CP07A, 36 cm above CP07, increases from 6.5 kPa to about 8 kPa, and the differential pressure CP07-CP07A dropped to a very low value (0.14 kPa), suggesting that the existing moving bed condition of CP07-BP03 has extended up to the section of CP07A-CP07. With unchanged CP08, the differential pressure of CP07A-CP08 increased to 6.3 kPa, suggesting that the dense packed bed height is further increased. From the previous gas-solid flow analysis, for the gas and solid downward moving bed section, very low pressure drop in this section would suggest that the slip velocity is low based on modified Ergun Equation. With the continuing BP03 decrease and existing differential pressure CP02-CP03, it could suggest that the solid flow from gasifier through U-bend, CFB riser and cyclone is continuing, but the restriction exists in the downcomer end section, the solids are not fully returned back to BFB, and the dense solid packed bed is piled up in the downcomer.

As shown in FIG. 18 at 17:19, the CP08 was found to increase rapidly, from less than 2 kPa to more than 7 kPa within one minute time. The sudden increase of CP08 (top of the downcomer, 1.13 m below CFB cyclone) is an indication of the dense packed bed built up to the downcomer above the CP08 position, and CFB cyclone flooding will occur shortly if there is no further intervention from the operator.

The cause was then identified by the operator to be the misposition of the flapper inside of the trickle valve. The solid flow was restricted at this position. The trickle valve malfunction was found at the start of the study, and the flapper was kept open at all times. In this case it was quickly cleared by the operator. As shown in FIG. 18, the CP08 was dropped to its normal value, ˜2 kPa, after the restriction at the low end of downcomer was removed. It is interesting to note that CP08 once becomes the highest pressure along the downcomer under the above abnormal condition before CFB cyclone flooding. The pressure decreases from CP08 down to CP07 as shown in FIG. 19 (B), which suggests that a different moving bed flow pattern is formed. As shown in FIGS. 18 and 13 (D), the full recovery takes about 5-6 mins until 17:30 (pink line loop). The differential pressure of about 3.5 kPa CP07-CP07A has been reached (17:30 and 18:00), and the differential pressures of 1.5-2.3 kPa are found between CP07 and CP08, indicating the dense bed surface is still located above the CP07A position. All the moving bed sections in low downcomer (CP07A-CP07-BP03) exhibit solids downward moving bed with a positive slip velocity.

In subsequent runs, the flapper inside of the non-functioning trickle valve was completely removed to avoid potential misposition during the operation.

Control System Example Cases 1-4: Summary and Other Detection and Control Applications

The above Example Case Studies 1-4 were undertaken with the dual bed Gasifier operating at realistic temperatures i.e. >800° C. for the gasification step and some 80° C. higher for the combustor stage. In all four Cases, the “Before Correction” situation data indicated where in the Loop significant differences from the Target conditions of pressure drop occurred, i.e., in which part of the circulation loop the problem was occurring. These were evident from either ΔP values that were significantly different from that expected from the steady state target conditions in that portion of the loop, or where the pressure (or slip velocity) direction had been reversed from the conditions under normal operations, giving a negative rather than a positive pressure drop. In particular, the high initial values of (CP07A-CP08) under upsets of Cases 2, 3 and 4, indicate the value of having a pressure sensor located in the upper downcomer dilute solids section, sufficient distance from the cyclone, to indicate when cyclone flooding was imminent. In all three cases where an upset had created a change in gas-solid velocity direction (evident from a negative pressure drop in that segment of the loop), after control action the slip velocity direction was reversed to give a positive value for the ΔP in that loop segment. As well, for the “After Correction” data, all showed a partial or complete return of ΔP values towards the set point values. These Case Studies therefore demonstrate the efficacy of the proposed system to deal with circulation-related issues.

These Case Studies findings [Case Studies 1-4] Table 14, determined that accurate and sophisticated monitoring and control systems can be put in place simply by measuring the pressure at various locations within the gasifier. Fundamental to an improved control system, is an understanding of the multi-phase gas-solids flows in the different regions of the flow loop. Sections [0131] to [0147] include an analysis made that guides the design of the current system, and forms a basis for an improved control system. Other applications of the control system not tested in the present Case Studies include, but are not limited to the following hypothetical, but typical gasifier operation issues, and the solutions to those issues [Examples 5-9], Table 14.

Problem: Reduction in Air Flow to Char Combustor It is known from the published engineering literature (including [7]) that in a dual-bed gasifier system a decrease in the flow of air to the char combustor riser reactor will lower the circulation rate. Should this occur during operation, the pressure at CP02 and CP03 will decrease, and would be detected in the currently disclosed control system, through the measuring of pressure at CP02 and CP03. Solution: If such an issue arises, the air rate could then be raised to return the gasifier to set point conditions.

Problem: Increase in Pressure Downstream of the Dual-Bed Gasifier It is known from the published engineering literature (including [7]) that in a dual-bed gasifier the circulation rate will increase under conditions that the pressure in the gasifier reactor (both BP03 and BP04), will increase, and that the circulation will increase other factors being unchanged. The pressure increase can occur during operation caused by, for example, partial blocking of downstream piping or filter by deposition of tars or tars plus solids. Solution: If such an issue occurs, the circulation change would be detected as a pressure change in the lower branch, and control actions would be taken to bring the dual-bed back to set points, until steps can be initiated to remove the partial blockage.

Problem: Bubble and Slugging Formation in the Stand-pipe. This is caused by excess aeration gas use. Solution: Decrease aeration gas at L-valve or Loop-seal.

Problem: Pressure decrease in the solid flow direction, solid in stick-slip flow rather than smooth moving bed, because Moving bed height is too high. Solution: Increase aeration gas at L-valve and along the standpipe.

Problem: Moving Bed keeps increasing or decreasing in height. Solution: Increase or decrease aeration gas at L-valve.

Table 14 summarizes the detection of process upsets and the controlling response of the system, including the four Example cases described above, as well as five further example problems case studies. Although the presently disclosed gasifier monitoring and control system describes pressure sensors at 10 (or more) different locations within the gasifier, the summary in Table 14 shows the sensor data that was utilized to detect and control for possible gasifier operation abnormalities. As can be seen, in some cases (for example, case study 6), only two pressure sensors, at positions P1 and P2, were required to detect (and correct) the abnormality. For other abnormalities, other sensors were utilized.

TABLE 14
Dual Bed Gasifier Control System Problem Detection and Solution Summary

| Case | Operating | Detection of Upset via | | Used P |
|---|---|---|---|---|
| Study* | Problem | Pressure Drop | Control Solution | Data |
| 1 | Gasifier bed | Low UMP-BPO3(P3-P2) | Increase U-bend | P2, P3, P4 |
| | temperature drop | low UMP-CP02(P3-P4) | aeration gas flow | |
| 2 | Surge of make-up | Negative pressure drop of | Adjust lower | P2, P7, P8, P9 |
| | solids into downcomer | CP07-CP07A (P9-P8)or | downcomer aeration gas | |
| | | BP03-CP07(P2-P9), high | flow to lower CP07- | |
| | | pressure drop of CP07A- | CP08, and to turn | |
| | | CP08 (P8-P7) | pressure drop (s) of | |
| | | | CP07-CP07A or BP03- | |
| | | | CP07 positive | |
| 3 | Imminent Cyclone | High pressure drop of | Increase aeration gas to | P2, P7, P8, P9 |
| | Flooding | CP07A-CP08(P8-P7) | lower downcomer | |
| | | Negative pressure drop of | standpipe dense bed | |
| | | BP03-CP07(P2-P9) | height and to obtain | |
| | | | positive pressure drop of | |
| | | | BP03-CP07 | |
| 4 | Blockage of | High pressure drop of CP07- | Remove mechanical | P2, P3, P7, P8, P9 |
| | combustor | CP08 (P8-P7), low pressure | blockage, adjust lower | |
| | downcomer | drops of CP07-CP07A (P9- | downcomer aeration | |
| | | P8) and BP03-CP07 (P2-P9), | flow | |
| | | pressure drop of UMP- | | |
| | | BP03(P3-P2) turns from | | |
| | | positive to negative | | |

Other Examples**

| | | | | |
|---|---|---|---|---|
| 5 | Drop in air flow to | Pressure P04, P05 decrease | Raise air flow rate to | P4, P5 |
| | Combustor | | char combustor | |
| 6 | Downstream of | Increased pressure in gasifier | Actuate combustor flue | P1, P2 |
| | gasifier pressure | P1 and P2 | gas damper to increase | |
| | increase | | P04 and P05 synchronously. | |
| | | | Clear syngas | |
| | | | downstream resistance | |
| | | | to lower gasifier P1 and | |
| | | | P2. | |
| 7 | Solid flow rate | Pressure drops of P9-P8 and | Adjust aeration gas | P2, P3, P7, P8, P9 |
| | impacted by bubble or | P8-P7 or P3-P2 fluctuate | flows (3×) at the L-valve | |
| | slug formation in | significantly, may become | or Loop-seal, reduce the | |
| | downcomer or low | negative. Downcomer | aeration gas at the | |
| | branch standpipe. | standpipe dense bed height | vertical and bottom of | |
| | | increases. | the valves. | |
| 8 | Stick-slip Flow in | Negative pressure drop (s) in | Increase aeration gas at | P7, P8, P9 |
| | Standpipe | the moving bed section (s) of | L-Valve/Loop-Seal, and | |
| | | downcomer | along the standpipe | |
| 9 | Downcomer moving | Downcomer pressure (s), P7, | Adjust aeration gas | P7, P8, P9 |
| | bed height | P8 and P9 increase/decrease | flows (3×) at the L-valve | |
| | increase/decrease | | or loop-seal | |

*Refer to FIG. 5 for Pilot Plant pressure measurement locations
**Refer to FIG. 3 for Commercial Dual Bed Gasifier measurement location

Pressure Drop Through the Moving Bed Sections and Gas Leakage Calculation

In FIG. 3, moving bed sections are formed in the solids recirculation loop in the lower section in of the downcomer above the L-valve, and from the gasifier bottom through the U-bend to the combustor bottom. In FIG. 4, the moving bed sections are in the downcomer above the loop seal , and in the gasifier exit line above the loop seal. These moving bed sections are critical for the solid recirculation and for preventing the combustible syngas in the gasifier from mixing with the flue gas in the combustor. The pressure drop across the above moving beds is determined by the slip velocity, and can be estimated by the modified Ergun equation:

$$\frac{Δ P}{Δ L} = 150 {( \frac{1 - ε}{ε} )}^{2} \frac{{μ}_{g} \vert {U}_{sl} \vert}{{( φ {d}_{p} )}^{2}} + 1.75 ( \frac{1 - ε}{ε} ) \frac{{ρ}_{g} {U}_{sl}^{2}}{φ {d}_{p}} \qquad ( C - 1 )$$

where μ_{g}, ρ_{g}, φ, and dₚ are gas viscosity, gas density, particle sphericity and mean particle size, respectively. From the measured pressure drop, and the known properties of the system, Eqn. C-1 is solved for the slip velocity Uₛₗ, which is related to the actual gas and actual solid velocities by

$${U}_{sl} = {U}_{g} - {U}_{s} = \frac{{U}_{g}^{0}}{ε} - \frac{{U}_{s}^{0}}{( 1 - ε )} \qquad ( C - 2 )$$

where U_{g} and Uₛ are the actual gas and solid velocities, respectively, U⁰_{g} and U⁰ₛ are the superficial gas and solid velocities, respectively. ε is the bed voidage, its value is expected to be slightly smaller than that at minimum fluidization velocity, ε_{mf}, but slightly larger than the packed bed voidage, ε_{c}, i.e., ε_{c}<ε<ε_{mf}.

To ensure that the test sections are actually in the moving bed flow regime, values are checked with solid-gas phase diagrams, or other mathematical models. For a given situation for example, calculations may make use of the gas-solid phase diagram of H. Li, (1991) [8] to confirm that the flows in the test sections are indeed in the moving bed regime (Appendix B).

From Equation (C-2), it is seen that the slip velocity depends on both gas and solid velocities, as well as their relative directions.

Knowing the slip velocity, Uₛₗ, the gas velocity, U_{g} can be determined by Equation (C-2) if the solid flow or flux across the same moving bed section, Wₛ or Gₛ (kg/s, or kg/m²·s), is specified (e.g., from the dual bed system mass and energy balance). This permits an estimate of the gas flows (or leakages), V_{L}, that entering or exiting the sections next to it (i.e., gasifier or combustor), and comparing with the actual flow rates of the next sections (e.g., V_{gasifier} or V_{combustor})

$${V}_{L} = {U}_{g}^{0} A = {U}_{g} ε A = ( {U}_{sl} + {U}_{s} ) ε A = {U}_{sl} ε A + \frac{{W}_{s} ε}{{ρ}_{p}} \qquad ( C - 3 )$$

The gas volumetric flows in both gasifier or combustor, V_{g}(@T_{g}) or V_{c}(@T_{c}) (e.g., Am³/h) can be estimated from the gasifier and combustor operation condition and hot raw syngas and flue gas exited from the gasifier and combustor.

From the measured Upper Branch and Lower Branch pressure drops, the slip velocities can be estimated from the modified Ergun Equation, Uₛₗ₍ᵤₚₚₑᵣ₎ and U_{sl(lower)} (m/s).

The solid circulation rate is estimated from dual bed system mass and energy balance, Wₛ (kg/m²·s), noting based on the cross section area of the upper and low section branches at steady condition. The actual solid velocity Uₛ, can be evaluated to be Uₛ=Wₛ/[ρₚ (1-249 )], where ρₚ is the particle density (e.g., for silica sand, ρₚ=2600 kg/m³), ε is the dense moving bed voidage (e.g., ε=0.44 for dₚ=143 μm) having the value within a small range between εₚ (e.g., εₚ=0.43) and ε_{mf} (e.g., ε_{mf}=0.45).

From the definition of the slip velocity, Uₛₗ=U_{g}−Uₛ (upward positive), the actual gas velocities in both Upper and Lower Branches can be evaluated to be U_{g(upper)} and U_{g(lower)}, if the value is negative meaning that the gas is flowing downward. The superficial velocities of the two sections can be obtained from the relationship, U⁰_{g(upper)}=εU_{g(upper)} and U⁰_{g(lower)}=εU_{g(lower)}. The volumetric interstitial gas flow rates V₍ᵤₚₚₑᵣ₎ and V_{(lower)} can be estimated by the formulas if the upper and lower branches cross section areas, A₍ᵤₚₚₑᵣ₎ and A_{(lower)}, are different:

V₍ᵤₚₚₑᵣ₎=A₍ᵤₚₚₑᵣ₎×U⁰_{g(upper)} (C-4)

V_{(lower)}=A_{(lower)}×U⁰_{g(lower)} (C-5)

To estimate the significance of the leakages from the downcomer to the gasifier, or from the gasifier to the combustor, the above gas volumetric flows can be compared with gasifier and combustor actual volumetric flow rates (V_{g} and V_{c}), expressed as the % of V_{g} or V_{c}:

% leakage into gasifier=V₍ᵤₚₚₑᵣ₎/V_{g}×100% (C-6)

% leakage into combustor=V_{(lower)}/V_{c}×100 (C-7)

Detailed Analysis Based on the Gas-Solid Flow Map of H. Li (1991) [8]

An analysis based on the phase diagram of H. Li (1991), gives a detailed understanding of the flows in dual bed systems. It requires a background set of equations that would reside in the “controller” software of the plant computers. The calculations confirmed that the instrumented test sections were indeed in the dense moving bed regime, the basis for this patent application, and showed where other flow regimes occurred. This approach would allow fine tuning of the calculations to quantifiably indicate the magnitude of the adjustments needed to return the system to its set point, which is not incorporated in the simpler herebefore described set-point comparisons.

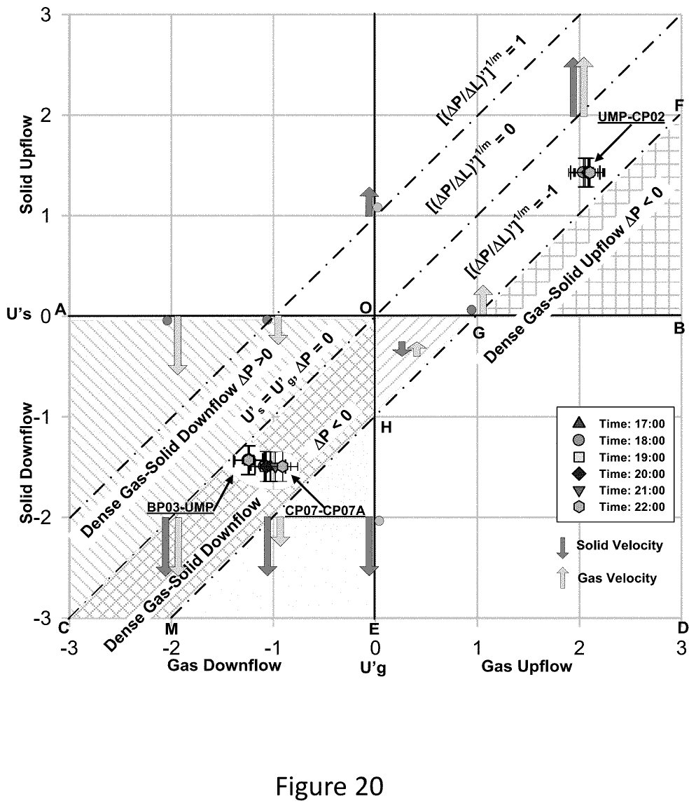

FIG. 20 is a simplified fluid-particle phase diagram adopted from H. Li, (1991) [8], in which the dimensionless gas and solid velocities, U′ₛ=Uₛ/U_{mf}, U′_{g}=U_{g}/U_{mf} can be graphically presented in the diagram with a slope of the line=1 and an intercept [(dP/dL)′]^{1/m}.

As described by the author (H. Li, 1991) [8] moving dense bed operation can occur in four sections of the phase diagram: (AOC, OCMH, OHG, and BFG), when solids motion is initiated only by gravity and drag forces.

The line AOB separates solid upflow and downflow. The regimes AOC and OCMH represent the cocurrent-cogravity gas-solid downflow moving bed operations, (i.e., both gas and solids flow downwards which are of interest in the present application). The dashed OC line is the zero pressure drop condition, where the reduced solid velocity, U′ₛ equals to the reduced gas velocity, U′_{g}. To the right, the solid moves down concurrently with the gas, under the downward gravity force and partially supported by upward fluid drag with a negative pressure drop (from upper to lower). The bed voidage, ε, is found to be between the minimum fluidization voidage, &mf, and the vibrated packed bed voidage, εₚ. The line, HM, represents the limited moving bed condition, where the upward slip velocity, Uₛₗ, between the gas and solid, reaches the actual minimum fluidization velocity, U_{mf}/ε_{mf}, i.e., the gas-solid flow becomes fluidized. On the other hand, to the left of the line OC, the gas-solid is also a cocurrent-cogravity gas-solid downflow moving bed, but the solids move down under both gravity and downward fluid drag forces, and tend to arrange themselves to the voidage of the vibrated packed bed, εₚ. A small triangular area, OGH, is a countercurrent-cogravity gas-solid flow, where the line, GH, shows the limit of the moving bed condition.

The regime, BFG, represents the cocurrent-countergravity gas-solid upflow, the solid moves up supported by the upward fluid drag force. As shown by the point G, the minimum actual upward gas velocity, U_{g}=U_{mf}, and up on the increase of upward solid velocity, the gas velocity could be several times of the minimum fluidized velocity, e.g., U′_{g}=3 along the line BF. As the stable upward moving bed, the line GF shows the limitation of the gas-solid moving bed flow mode.

In the practical operations, the gas or solid velocities could not be measured directly. Information on pressure profiles is often available. In the above described fluid-particle phase diagram, the operable moving bed operation regimes are found to be associated with specific pressure profiles. For example, the area OCMH of the cocurrent-cogravity gas-solid downflow moving bed exhibits a negative (from upper to down) pressure drop with an upward slip velocity, and the same solid downflow could have a positive pressure drop with a downward slip velocity in the area AOC with large downward gas flow. From the measured pressure profiles as shown in Table 8 (of the main text), it can be analysed to provide much more detailed understanding of the flows in dual bed systems.

Automated System for Optimizing Gasifier Conditions

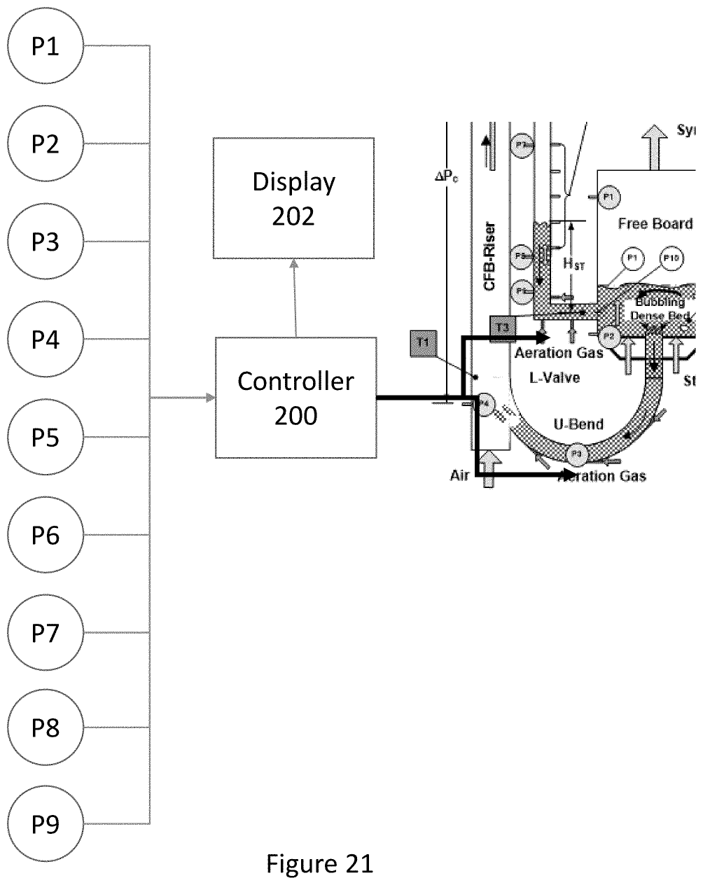

As summarized, for example, in Table 14, understanding pressure conditions at various locations within the gasifier can be used to correct many of the common gasifier operation problems. This can be automated. A schematic representation of such a control system is shown in FIG. 21. For example, the pressure sensors (P1-P9) as hereindescribed can be connected to a microprocessor—based controller 200, which can also control aeration gas flow at various locations in the gasifier, such as the non-mechanical valves, or the downcomer aeration gas flow. The microprocessor-based controller can monitor pressure at set times, continuously, or intermittently. Where certain pressure thresholds are met, for example, where there is a pressure drop between P3 and P2, and a pressure drop between P3 and P4 (case study 1), the microprocessor-based controller can automatically increase the U-bend aeration gas flow, until the pressure normalizes. “Pressure tuning” of this nature can occur for example, only in extreme problem situations, or can be a continuous, fine tuning, to continually provide desirable pressure conditions. Similar pressure tuning can occur in a similar fashion, for many of case studies 1-9 described in Table 14 and above. In certain situations, for example, in case study 4 (blockage of combustor downcomer), where user intervention may be required to remove a mechanical blockage, the microprocessor-based controller may attempt to clear the blockage by adjusting the lower downcomer aeration flow, but, if unsuccessful, may trigger an alarm or alert on a screen or display panel 202, alerting a user that intervention is required, or execute emergency shut-down procedures if needed. In certain embodiments, temperature sensors are also utilized.

The purpose of the above description is to illustrate some configurations and uses of the present invention, without implying any limitation. It will be apparent to those skilled in the art that various modifications and variations may be made in the process and product of the invention without departing from the spirit or scope of the invention.

References (all incorporated herein by reference)

### ADDIN EN.REFLIST

1. Leung, L. S., P. J. Jones, and T. M. Knowlton, An analysis of moving-bed flow of solids down standpipes and side valves. Powder Technology, 1978. 19(1): p. 7-15.
2. Basu, P., Solid Recycle Systems, in Combustion and Gasification in Fluidized Beds. 2006, CRC Press. p. 417-437.
3. Knowlton, T. M., Nonmechanical control of solids flow in single and multi-loop systems. 2012. 17(1): p. 25-49.
4. Wang, C., et al., Detailed measurements of particle velocity and solids flux in a high density circulating fluidized bed riser. Chemical Engineering Science, 2014. 114: p. 9-20.
5. Azizaddini, S., A New Type of Non-Mechanical Valves for Recirculation of Fine Particles, in Department of Chemical and Biochemical Engineering. 2016, Technical University of Denmark (DTU).
6. Knowlton, T. M. and S. B. R. Karri, Standpipes and Return Systems, Separation Devices, and Feeders, in Essentials of Fluidization Technology. 2020. p. 203-237.
7. Li, Y. H., et al., A novel dual-bed for steam gasification of biomass. Biomass Conversion and Biorefinery, 2018. 8(2): p. 357-367.
8. Li, H., The fluid—particle flow phase diagram and the ideal sealing state for a vertical moving bed. Powder Technology, 1991. 67(1): p. 37-42.

1. A solid circulation monitoring system for a dual-bed gasification apparatus, said dual-bed gasification apparatus comprising:
a gasifier having a bed and a freeboard;
a combustor having a bottom end and a top end;
a lower branch conduit connecting the gasifier to the combustor;
said lower branch conduit configured to allow transfer of heat carrier particles from the gasifier to the combustor;
an upper branch conduit connecting the combustor to the gasifier;
said upper branch conduit configured to allow transfer of heat carrier particles from the combustor to the gasifier;
said upper branch conduit having an upper portion, a middle portion, and a lower portion;
said monitoring system comprising a plurality of pressure sensors, each measuring a pressure at a location within the dual-bed gasification apparatus while the dual-bed gasification apparatus is in operation.

2. The solid circulation monitoring system of claim 1 further comprising a plurality of temperature sensors, each measuring a temperature at a location within the dual-bed gasification apparatus while the dual-bed gasification apparatus is in operation.

3. The solid circulation monitoring system of claim 1 wherein the plurality of pressure sensors comprise two or more of:
a pressure sensor P1 measuring a pressure PR1 within the freeboard;
a pressure sensor P2 measuring a pressure PR2 within the gasifier bed;
a pressure sensor P3 measuring a pressure PR3 in said lower branch conduit;
a pressure sensor P4 measuring a pressure PR4 in said bottom end of the combustor;
a pressure sensor P5 measuring a pressure PR5 in said top end of the combustor;
a pressure sensor P6 measuring a pressure PR6 in the top of the upper branch conduit;
a pressure sensor P7 measuring a pressure PR7 within the middle portion of the upper branch conduit;
optionally, one or more further pressure sensors P7A measuring a pressure PR7A within the middle portion of the upper branch conduit;
a pressure sensor P8 measuring a pressure PR8 within the lower portion of the upper branch conduit;
optionally, one or more further pressure sensors P8A measuring a pressure PR8A within the lower portion of the upper branch conduit;
a pressure sensor P9 measuring a pressure PR9 within the lower portion of the upper branch conduit and downstream of pressure sensor P8.

4. The solid circulation monitoring sensor of claim 2 wherein the plurality of temperature sensors comprise two or more of:
a temperature sensor T1 measuring a temperature TP1 at the bottom end of the combustor;
a temperature sensor T2 measuring a temperature TP2 in said top end of the combustor;
a temperature sensor T3 measuring a temperature TP3 directly upstream of the gasifier bed; and
a temperature sensor T4 measuring a temperature TP4 within the gasifier bed.

5. The solid circulation monitoring system of claim 3 comprising pressure sensor P1 and pressure sensor P2.

6. The solid circulation monitoring system of claim 3 comprising pressure sensor P2, pressure sensor P3, and pressure sensor P4.

7. The solid circulation monitoring system of claim 3 comprising pressure sensor P2, pressure sensor P7, pressure sensor P8, and pressure sensor P9.

8. The solid circulation monitoring system of claim 7 further comprising pressure sensor P3.

9. The solid circulation monitoring system of claim 3 comprising pressure sensor P4 and pressure sensor P5.

10. The solid circulation monitoring system of claim 3 comprising pressure sensor P7, pressure sensor P8, and pressure sensor P9.

11. The solid circulation monitoring system of claim 10 further comprising pressure sensor P2 and pressure sensor P3.

12. The solid circulation monitoring system of claim 3 comprising pressure sensor Pl, pressure sensor P2, pressure sensor P3, pressure sensor P4, pressure sensor P5, pressure sensor P6, pressure sensor P7, pressure sensor P8, pressure sensor P9, and, optionally, one or more of pressure sensor P7A and pressure sensor P8A.

13. A system for controlling solids circulation in a dual-bed gasification apparatus, said dual-bed gasification apparatus comprising:
a gasifier having a bed and a freeboard;
a combustor having a bottom end and a top end;
a lower branch conduit connecting the gasifier to the combustor;
said lower branch conduit configured to allow transfer of heat carrier particles from the gasifier to the combustor;
said lower branch conduit optionally having a lower branch non-mechanical device permitting control of rate of passage of said heat carrier particles from the gasifier to the combustor;
an upper branch conduit connecting the combustor to the gasifier;
said upper branch conduit configured to allow transfer of heat carrier particles from the combustor to the gasifier;
said upper branch conduit having an upper portion, a middle portion, and a lower portion;
said lower portion of the upper branch conduit optionally having an upper branch non-mechanic device permitting control of rate of passage of said heat carrier particles from the combustor to the gasifier;
said control system comprising the solid circulation monitoring system of claim 1,
wherein the lower branch non-mechanical device and/or the upper branch non-mechanical device are operated to increase or decrease the passage of said heat carrier particles in response to changes in pressure PR1, PR2, PR3, PR4, PR5, PR6, PR7, PR8, and/or PR9, and optionally one or more of PR7A and PR8A.

14. The system for controlling solids circulation of claim 13, wherein the lower branch non-mechanical device and/or the upper branch non-mechanical device is an L-valve, a J-valve, an approximated J-valve, a seal pot, a U-bend, or a loop seal, and the operating of said non-mechanical device comprises adjusting a rate of flow of aeration gas through said non-mechanical device.

15. The system for controlling solids circulation of claim 13, further comprising upper aeration ports in said upper branch conduit and/or lower aeration ports in said lower branch conduit, and the upper aeration ports and/or lower aeration ports are operated to increase or decrease the passage of said heat carrier particles in response to changes in pressure PR1, PR2, PR3, PR4, PR5, PR6, PR7, PR8, and/or PR9, and optionally one or more of PR7A and PR8A.

16. The system for controlling solids circulation of claim 13, wherein the operating of the lower branch non-mechanical device and/or the upper branch non-mechanical device occurs in an automated fashion in response to the change in pressure PR1, PR2, PR3, PR4, PR5, PR6, PR7, PR8, and/or PR9, and optionally one or more of PR7A and PR8A.

17. A method for controlling solids circulation in a dual-bed gasification apparatus, said dual-bed gasification apparatus comprising:
a gasifier having a bed and a freeboard;
a combustor having a bottom end and a top end;
a lower branch conduit connecting the gasifier to the combustor;
said lower branch conduit configured to allow transfer of heat carrier particles from the gasifier to the combustor;
said lower branch conduit optionally having a lower branch non-mechanical device permitting control of rate of passage of said heat carrier particles from the gasifier to the combustor;
an upper branch conduit connecting the combustor to the gasifier;
said upper branch conduit configured to allow transfer of heat carrier particles from the combustor to the gasifier;
said upper branch conduit having an upper portion, a middle portion, and a lower portion;
said lower portion of the upper branch conduit optionally having an upper branch non-mechanical device permitting control of rate of passage of said heat carrier particles from the combustor to the gasifier;
said method comprising monitoring, while the dual-bed gasification apparatus is in operation, a plurality of pressures, each pressure at a location within the dual-bed gasification apparatus, and increasing or decreasing one or more of: (a) the rate of passage of the heat carrier particles from the combustor to the gasifier by operating the upper branch non-mechanic device; and (b) increasing or decreasing the rate of passage of the heat carrier particles from the gasifier to the combustor, by operating the lower branch non-mechanic device; when one or more of said plurality of pressures, or where the difference between two of said plurality of pressures reach a defined threshold.

18. The method of claim 17 further comprising increasing or decreasing an aeration gas flow to the lower portion and/or the middle portion of the upper branch conduit, when one or more of said plurality of pressures, or where the difference between two of said plurality of pressures, reach a defined threshold.

19. The method of claim 17 wherein the plurality of pressures comprise two or more of:
a pressure PR1 within the freeboard;
a pressure PR2 within the gasifier bed;
a pressure PR3 in said lower branch conduit;
a pressure PR4 in said bottom end of the combustor;
a pressure PR5 in said top end of the combustor;
a pressure PR6 within the upper portion of the upper branch conduit;
a pressure PR7 within a middle portion of the upper branch conduit;
a pressure PR8 within the lower portion of the upper branch conduit;
a pressure PR9 within the lower portion of the upper branch conduit and downstream of pressure sensor P8;
a pressure PR7A measuring a pressure PR7A within the middle portion of the upper branch conduit;
a pressure PR8A measuring a pressure PR8A within the lower portion of the upper branch conduit.
